(19) United States
(12) Patent Application Publication
(10) Pub. No.: US 2025/0183968 A1
(43) Pub. Date: Jun. 5, 2025

(54) METHOD FOR FEEDBACK of CHANNEL STATE INFORMATION, DATA TRANSMISSION METHOD, APPARATUS AND SYSTEM

(71) Applicant: FUJITSU LIMITED, Kawasaki-shi (JP)

(72) Inventors: Qun ZHANG, Beijing (CN); Xin WANG, Beijing (CN); Gang SUN, Beijing (CN); Jian ZHANG, Beijing (CN); Lei ZHANG, Beijing (CN); Guorong LI, Beijing (CN); Qinyan JIANG, Beijing (CN)

(73) Assignee: FUJITSU LIMITED, Kawasaki-shi (JP)

(21) Appl. No.: 19/023,982

(22) Filed: Jan. 16, 2025

Related U.S. Application Data
(63) Continuation of application No. PCT/CN2022/110696, filed on Aug. 5, 2022.

(51) Int. Cl. H04B 7/06; H04B 7/0456; H04W 24/02

(52) U.S. Cl. CPC H04B 7/0626; H04B 7/0456; H04W 24/02

(57) ABSTRACT

A data transmission method, a method for feedback of channel state information, an apparatus and a system, the data transmission method including: a network device transmits first information to a terminal equipment, the first information indicating the terminal equipment to generate and feedback channel state information; the network device receives channel state information of N layers transmitted by the terminal equipment, wherein N≥2 and channel state information of at least two layers of the channel state information of N layers is indicated by unequal numbers of bits; and the network device transmits data to the terminal equipment according to the channel state information of N layers.

### CROSS-REFERENCE TO RELATED APPLICATION

This application is a continuation application of International Application PCT/CN2022/110696 filed on Aug. 5, 2022, and designated the U.S., the entire contents of which are incorporated herein by reference.

### TECHNICAL FIELD

The present disclosure relates to the field of communications.

### BACKGROUND

In the Multiple Input Multiple Output (MIMO) technology, a terminal equipment measures a spatial channel and feeds back Channel State Information (CSI) to a base station. According to the channel state information reported by the terminal equipment, the base station may select an appropriate precoding matrix to perform downlink transmission with the terminal equipment, thereby reducing a received bit error probability of the terminal equipment as much as possible.

It should be noted that the above introduction to the technical background is just to facilitate a clear and complete description of the technical solutions of the present disclosure, and is elaborated to facilitate the understanding of persons skilled in the art. It cannot be considered that said technical solutions are known by persons skilled in the art just because these solutions are elaborated in the Background of the present disclosure.

### SUMMARY

The inventor finds that since the same modulation coding scheme (MCS) for different downlink transmission layers are used in a related art, a design of the MCS needs to satisfy reliable transmission of a sub-channel (layer) with the worst signal-to-noise ratio.

For the above problem, embodiments of the present disclosure provide a method for feedback of channel state information, a data transmission method, apparatus and system, to improve transmission performance of all sub-channels by reinforcing one or more channels that are relatively poor.

According to an aspect of the embodiments of the present disclosure, an apparatus for feedback of channel state information, configured in a terminal equipment, the apparatus including:
a receiving unit configured to receive first information transmitted by a network device, the first information indicating the terminal equipment to generate and feedback channel state information;
a generating unit configured to generate channel state information of N layers according to a first rule that is predefined or preconfigured or configured by the network device, wherein N≥2 and channel state information of at least two layers of the channel state information of N layers is indicated by unequal numbers of bits; and
a transmitting unit configured to transmit the channel state information of N layers to the network device.

According to another aspect of the embodiments of the present disclosure, a data transmission apparatus is provided, configured in a network device, the apparatus including:
a first transmitting unit configured to transmit first information to a terminal equipment, the first information indicating the terminal equipment to generate and feedback channel state information;
a receiving unit configured to receive channel state information of N layers transmitted by the terminal equipment, wherein N≥2 and channel state information of at least two layers of the channel state information of N layers is indicated by unequal numbers of bits; and
a second transmitting unit configured to transmit data to the terminal equipment according to the channel state information of N layers.

One of the advantageous effects of the embodiments of the present disclosure lies in: according to the embodiments of the present disclosure, transmission performance of all sub-channels is improved by reinforcing one or more channels that are relatively poor.

Referring to the later description and drawings, specific implementations of the present disclosure are disclosed in detail, indicating a mode that the principle of the present disclosure may be adopted. It should be understood that the implementations of the present disclosure are not limited in terms of a scope. Within the scope of the terms of the attached claims, the implementations of the present disclosure include many changes, modifications and equivalents.

Features that are described and/or shown for one implementation may be used in the same way or in a similar way in one or more other implementations, may be combined with or replace features in the other implementations.

It should be emphasized that the term “comprise/include” when being used herein refers to presence of a feature, a whole piece, a step or a component, but does not exclude presence or addition of one or more other features, whole pieces, steps or components.

### BRIEF DESCRIPTION OF DRAWINGS

An element and a feature described in a drawing or an implementation of the embodiments of the present disclosure may be combined with an element and a feature shown in one or more other drawings or implementations. In addition, in the drawings, similar labels represent corresponding components in several drawings and may be used to indicate corresponding components used in more than one implementation.

The included drawings are used to provide a further understanding on the embodiments of the present disclosure, constitute a part of the Specification, are used to illustrate the implementations of the present disclosure, and expound the principle of the present disclosure together with the text description. Obviously, the drawings in the following description are only some embodiments of the present disclosure. Persons skilled in the art may further obtain other drawings according to these drawings under the premise that they do not pay inventive labor. In the drawings:

FIG. 1 is a schematic diagram of generation and feedback of CSI based on a traditional codebook method;

FIG. 2 is a schematic diagram of generation and feedback of CSI based on an AI/ML method;

FIG. 3 is a schematic diagram of a two-sided AI/ML model;

FIG. 4 is a schematic diagram of a method for feedback of channel state information in the embodiments of the present disclosure;

FIG. 5 is a schematic diagram of an example of a method in the embodiments of the present disclosure;

FIG. 6 is a schematic diagram of another example of a method in the embodiments of the present disclosure;

FIG. 7 is a schematic diagram of a further example of a method in the embodiments of the present disclosure;

FIG. 8 is a schematic diagram of a data transmission method in the embodiments of the present disclosure;

FIG. 9 is a schematic diagram of an apparatus for feedback of channel state information in the embodiments of the present disclosure;

FIG. 10 is a schematic diagram of a data transmission apparatus in the embodiments of the present disclosure;

FIG. 11 is a schematic diagram of a communication system in the embodiments of the present disclosure;

FIG. 12 is a schematic diagram of a terminal equipment in the embodiments of the present disclosure;

FIG. 13 is a schematic diagram of a network device in the embodiments of the present disclosure.

### DETAILED DESCRIPTION

Referring to the drawings, through the following Specification, the aforementioned and other features of the present disclosure will become obvious. The Specification and the drawings specifically disclose particular implementations of the present disclosure, showing partial implementations which may adopt the principle of the present disclosure. It should be understood that the present disclosure is not limited to the described implementations, on the contrary, the present disclosure includes all the modifications, variations and equivalents falling within the scope of the attached claims.

In the embodiments of the present disclosure, the term “first” and “second”, etc. are used to distinguish different elements in terms of appellation, but do not represent a spatial arrangement or time sequence, etc. of these elements, and these elements should not be limited by these terms. The term “and/or” includes any and all combinations of one or more of the associated listed terms. The terms “include”, “comprise” and “have”, etc. refer to the presence of stated features, elements, members or components, but do not preclude the presence or addition of one or more other features, elements, members or components.

In the embodiments of the present disclosure, the singular forms “a/an” and “the”, etc. include plural forms, and should be understood broadly as “a kind of” or “a type of”, but are not defined as the meaning of “one”; in addition, the term “the” should be understood to include both the singular forms and the plural forms, unless the context clearly indicates otherwise. In addition, the term “according to” should be understood as “at least partially according to . . . ”, the term “based on” should be understood as “at least partially based on . . . ”, unless the context clearly indicates otherwise.

In the embodiments of the present disclosure, the term “a communication network” or “a wireless communication network” may refer to a network that meets any of the following communication standards, such as Long Term Evolution (LTE), LTE-Advanced (LTE-A), Wideband Code Division Multiple Access (WCDMA), High-Speed Packet Access (HSPA) and so on.

And, communication between devices in a communication system may be carried out according to a communication protocol at any stage, for example may include but be not limited to the following communication protocols: 1G (generation), 2G, 2.5G, 2.75G, 3G, 4G, 4.5G, and future 5G, New Radio (NR) and so on, and/or other communication protocols that are currently known or will be developed in the future.

In the embodiments of the present disclosure, the term “a network device” refers to, for example, a device that accesses a terminal equipment in a communication system to a communication network and provides services to the terminal equipment. The network device may include but be not limited to the following devices: a Base Station (BS), an Access Point (AP), a Transmission Reception Point (TRP), a broadcast transmitter, a Mobile Management Entity (MME), a gateway, a server, a Radio Network Controller (RNC), a Base Station Controller (BSC) and so on.

The base station may include but be not limited to: a node B (NodeB or NB), an evolution node B (eNodeB or eNB) and a 5G base station (gNB), etc., and may further includes a Remote Radio Head (RRH), a Remote Radio Unit (RRU), a relay or a low power node (such as femto, pico, etc.). And the term “base station” may include some or all functions of a base station, each base station may provide communication coverage to a specific geographic region. The term “cell” may refer to a base station and/or its coverage area, which depends on the context in which this term is used.

In the embodiments of the present disclosure, the term “a User Equipment (UE)” refers to, for example, a device that accesses a communication network and receives network services through a network device, or may also be called “Terminal Equipment (TE)”. The terminal equipment may be fixed or mobile, and may also be called a Mobile Station (MS), a terminal, a user, a Subscriber Station (SS), an Access Terminal (AT) and a station and so on.

The terminal equipment may include but be not limited to the following devices: a Cellular Phone, a Personal Digital Assistant (PDA), a wireless modem, a wireless communication device, a handheld device, a machine-type communication device, a laptop computer, a cordless phone, a smart phone, a smart watch, a digital camera and so on.

For another example, under a scenario such as Internet of Things (IoT), the terminal equipment may also be a machine or apparatus for monitoring or measurement, for example may include but be not limited to: a Machine Type Communication (MTC) terminal, a vehicle-mounted communication terminal, a Device to Device (D2D) terminal, a Machine to Machine (M2M) terminal and so on.

In the process of generation and feedback of current channel state information, a network device transmits a channel state information reference signal (CSI-RS) to each terminal equipment, and the terminal equipment estimates a channel via the received CSI-RS to obtain estimation of a spatial channel matrix. The terminal equipment further uses the estimated spatial channel matrix to obtain CSI. In new radio (NR), a feedback mode for the CSI is implicit feedback, that is, the terminal equipment feeds back CSI in a form of recommending transmission parameters to the network device, the transmission parameters therein include a channel state quality (CQI), a precoded matrix indication (PMI), a CSI-RS resource indication (CRI), an SSB resource indication (SSBRI), a layer indication (LI), a rank indication (RI), and a physical layer RSRP (L1-RSRP), etc. The network device may perform downlink transmission directly by using the parameters recommended by the terminal equipment or do not use the recommended parameters.

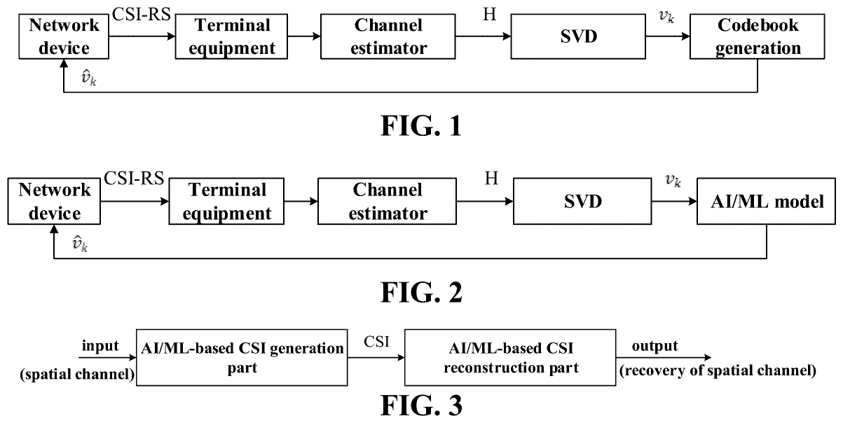

FIG. 1 is a schematic diagram of generation and feedback of CSI based on a traditional codebook method. As shown in FIG. 1, the network device transmits a CSI-RS to the terminal equipment, the terminal equipment performs channel estimation and singular value decomposition (SVD), generates CSI by using a traditional codebook generation method, and feeds back to the network device.

When the traditional codebook method is used to feedback the CSI, when a rank of a spatial channel matrix estimated by the terminal equipment is greater than 1, an RI (if reported) fed back by the terminal equipment to the network device may possibly be greater than 1. At this moment, the PMI is a codebook with multiple ranks. In NR Rel-15, two codebooks i.e., type I and type II, are defined. The former is a codebook with conventional precision, that may be used for SU-MIMO (single-user multiple-input multiple-output) and MU-MIMO (multi-user multiple-input multiple-output) transmissions. The latter is a codebook with high precision, mainly used in a MU-MIMO scenario. The latter has higher precision than the former, but has higher overhead. The two codebooks of NR adopt a parameterized codebook structure, divided into two levels (W=W₁W₂), where W₁ describes long-term and wideband characteristics of a channel and includes an oversampled DFT beam (group); W₂ describes short-term and subband characteristics of the channel. For the above two codebooks, methods for selecting W₁ are the same. For selection of W₂, W₂ of the type I codebook consists of weighted column selection vectors, a function is to select a beam for a subband from an oversampled beam in W₁. In the high-precision type II codebook, a function of W₂ is to linearly combine DFT beams in W₁.

In order to solve the problem of excessive overhead of the type II codebook, an enhanced type II codebook (e-type II codebook) is defined in Rel-16. The e-type II codebook still uses a two-level structure, that is, a group of beams of a broadband is reported, and then a group of combination coefficients of a narrow band is added for each beam. The enhancement of Rel-16 e-type II codebook is to reduce the overhead of reporting by using correlation of a frequency domain.

At the same time, e-type II CSI allows frequency domain granularity of the PMI reporting to be improved twice.

In 3GPP RAN 94 meeting, an AI/ML for NR air interface was agreed as a new study item (SI). Enhancement of a CSI feedback by using an AI/ML method is an important use case.

Different from traditional codebook-based CSI feedback, the AI/ML method does not use a codebook method to quantify spatial channel information, but uses an AI/ML method to process it to generate CSI.

FIG. 2 is a schematic diagram of generation and feedback of CSI based on an AI/ML method. As shown in FIG. 2, different from the method for generation and feedback of CSI based on a traditional codebook method in FIG. 1, in the method in FIG. 2, the terminal equipment uses an AI/ML model to generate CSI and feedback to the network device.

In 3GPP RAN 109-e meeting, the following agreement was reached for a structure of the AI/ML model:
For the evaluation of the AI/ML based CSI compression sub use cases, a two-sided model is considered as a starting point, including an AI/ML-based CSI generation part to generate the CSI feedback information and an AI/ML-based CSI reconstruction part which is used to reconstruct the CSI from the received CSI feedback information.
At least for inference, the CSI generation part is located at the UE side, and the CSI reconstruction part is located at the gNB side.

FIG. 3 is a schematic diagram of the aforementioned two-sided AI/ML model. As shown in FIG. 3, the UE uses an AI/ML-based CSI generation part of the model to process an input spatial channel to obtain CSI, the network device uses an AI/ML-based CSI reconstruction part of the model to reconstruct the obtained CSI to obtain recovery of the spatial channel as output. The two-sided AI/ML model shown in FIG. 3 is only an example, the present disclosure is not limited to this. The AI/ML model may further be set only at a UE side or only at a network device side, and for details, please refer to relevant technologies.

Various implementations of the present disclosure will be described below with reference to the drawings. These implementations are exemplary only and are not limitations to the present disclosure.

### Embodiments of a First Aspect

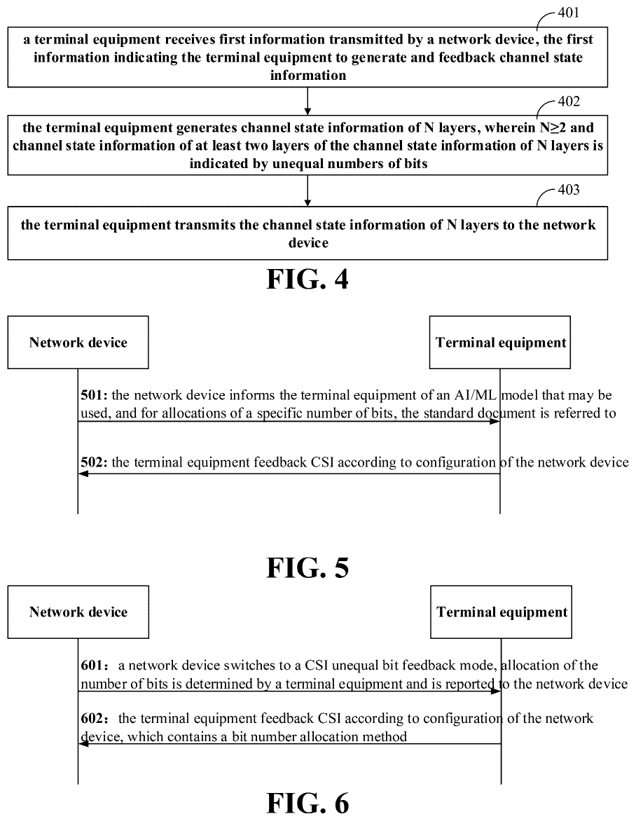

The embodiments of the present disclosure provide a method for feedback of channel state information, which is described from a terminal equipment side. FIG. 4 is a schematic diagram of a method for feedback of channel state information in the embodiments of the present disclosure, please refer to FIG. 4, the method includes:
401: a terminal equipment receives first information transmitted by a network device, the first information indicating the terminal equipment to generate and feedback channel state information;
402: the terminal equipment generates channel state information of N layers, wherein N≥2 and channel state information of at least two layers of the channel state information of N layers is indicated by unequal numbers of bits; and
403: the terminal equipment transmits the channel state information of N layers to the network device.

It should be noted that the above FIG. 4 only schematically describes the embodiments of the present disclosure, but the present disclosure is not limited to this. For example, an execution step of each operation may be adjusted appropriately, moreover some other operations may be increased or operations therein may be reduced. Persons skilled in the art may make appropriate modifications according to the above contents, not limited to the records in the above FIG. 4.

According to the above method in the embodiments of the present disclosure, unequal numbers of feedback bits are allocated to two or more subchannels, that is, different feedback precisions are used for two or more subchannels (or feedback precisions of two or more subchannels are further different), thus a system gain is improved.

In the embodiments of the present disclosure, the network device indicates the terminal equipment to generate and feedback CSI via the first information, the present disclosure does not restrict implementations of the first information, for example, the first information may be included in RRC signaling transmitted by the network device to the terminal equipment, the first information may be embodied as settings related to CSI reporting settings, and so on, and for details, relevant technologies may be referred to.

In the embodiments of the present disclosure, the channel state information of N layers may be generated based on a codebook, for example is generated in a mode shown in FIG. 1, or may be generated based on an AI/ML model, for example is generated in a mode shown in FIG. 2.

The method in the embodiments of the present disclosure will be described below by taking “a terminal equipment generates the above channel state information of N layers based on an AI/ML model” as an example.

In the embodiments of the present disclosure, a terminal equipment may generate channel state information of the N layers according to a rule (called a first rule) that is predefined or preconfigured or configured by a network device. The first rule includes but is not limited to one of the following or a combination thereof:
an available AI/ML model;
a criterion and/or method for selecting an AI/ML model;
a criterion and/or method for truncating CSI;
a method for approximating the number of feedback bits;
a maximum number of downlink transmission layers;
a maximum total number of feedback bits; and
a feedback order of CSI.

In the above and following descriptions of the embodiments of the present disclosure, unless otherwise specified, “predefined” refers to specified in a standard document, but the present disclosure is not limited to this, “predefined” may further refers to set when a product is of factory. Moreover, “preconfigured” refers to preconfigured by a network device, being static or semi-static, the present disclosure does not limit a configuration mode. In addition, “configured by a network device” refers to dynamically configured by a network device, for example configured by transmitting control information or configuration information or indication information or system information, the present disclosure does not limit a configuration mode.

In some embodiments, a network device and a terminal equipment reach the above consensus by means of being predefined or preconfigured or configured by the network device, the terminal equipment generates the above channel state information of N layers based on the consensus and feeds back to the network device, and the network device obtains the channel state information of N layers based on the consensus and transmits data to the terminal equipment based on recovered channel state information.

In the first rule, the number of the available AI/ML models may be one or more. For example, a network device configures an AI/ML model for a terminal equipment, and informs the terminal equipment that only its configured AI/ML model may be used. For another example, the network device configures multiple available models for the terminal equipment to select therein. For a further example, the network device and the terminal equipment reach a consensus in advance to agree on an available AI/ML model, and the terminal equipment uses an agreed AI/ML model (the number of the agreed AI/ML models is one), or the terminal equipment selects an AI/ML model from agreed AI/ML models (the number of the agreed AI/ML models is more than one).

In the first rule, the criterion and/or method for truncating CSI include(s):
if a length of a bit sequence of the CSI is greater than a specified length of a bit sequence, a truncation operation is performed on the bit sequence of the CSI;
if the length of the bit sequence of the CSI is the same as the specified length of the bit sequence, the bit sequence of the CSI is retained.

That the truncation operation is performed on the bit sequence of the CSI may refer to that a truncation operation is performed on the bit sequence of the CSI according to a second rule that is predefined or preconfigured or configured by a network device. The second rule here may refer to:
removing a component at a first position in the bit sequence of the CSI, so that the length of the obtained bit sequence of the CSI is the same as a specified length of a bit sequence, wherein the first position is one or more bits of any positions in the bit sequence of the CSI. For example, the first position is the first two or last two of the bit sequence of the CSI, and so on. In addition, the specified length of the bit sequence may be specified in a standard document, or may be predefined or preconfigured or configured by a network device.

The second rule is illustrated above, the present disclosure is not limited to this. For example, the second rule may further refer to:
performing IDFT (inverse discrete Fourier transform) operation on the bit sequence of the CSI, removing a component at a second position in the bit sequence of the CSI, and performing DFT (discrete Fourier transform) operation on an obtained bit sequence, so that a length of the obtained bit sequence of the CSI is the same as a specified length of a bit sequence, wherein the second position is one or more bits of any positions in the bit sequence of the CSI. For example, the second position is the first two or last two of the bit sequence of the CSI, and so on. In addition, the specified length of the bit sequence may be specified in a standard document, or may be predefined or preconfigured or configured by a network device.

In the first rule, the feedback order of CSI may be an order of values corresponding to CSI from large to small, or an order of the values corresponding to CSI from small to large, or other order agreed upon by a network device and a terminal equipment, as long as the network device and the terminal equipment reach a consensus in this regard. The values corresponding to CSI may be eigenvalues or singular values of a spatial channel matrix, the present disclosure is not limited to this. According to different generation modes of CSI, the values corresponding to CSI may further be others.

In the first rule, the AI/ML model may be a two-sided AI/ML model or may be a one-sided AI/ML model, wherein, the two-sided AI/ML (artificial intelligence/machine learning) model refers to that an AI/ML model is provided at a network device side and a terminal equipment side, as shown in FIG. 3, at the terminal equipment side, an AI/ML-based CSI generation part is provided, and, at the network device side, an AI/ML-based CSI reconstruction part is provided.

In addition, the one-sided AI/ML model refers to that an AI/ML model is provided at a network device side or a terminal equipment side, for example, at the terminal equipment side, an AI ML-based CSI generation part is provided, or, at the network device side, an AI/ML-based CSI reconstruction part is provided.

In some embodiments, the network device is not aware of an AI/ML model used by the terminal equipment, the terminal equipment may further transmit indication information to the network device to inform the network device of a serial number or index or identifier of an AI/ML model used by it to generate channel state information, so that the network device performs post-processing on the received channel state information accordingly, and recovers the post-processed channel state information.

The method in the embodiments of the present disclosure in a case of generating CSI based on an AI/ML model is illustrated below in conjunction with specific examples.

FIG. 5 is a schematic diagram of an example of a method in the embodiments of the present disclosure. As shown in FIG. 5, the method includes:
501: the network device informs the terminal equipment of an AI/ML model that may be used, and for allocations of a specific number of bits, the standard document is referred to;
502: the terminal equipment feeds back CSI according to configuration of the network device.

In the embodiments of the present disclosure, in the operation 501, the network device transmits a CSI-RS to the terminal equipment, and via the first information, configures or indicates the terminal equipment to feedback CSI of at least two layers of the CSI of N layers (N≥2) by using unequal numbers of bits, and the number of feedback bits of CSI of each layer is performed according to the Standard Text. In the operation 502, the terminal equipment receives the CSI-RS, performs channel estimation, and generates and feeds back the CSI of the N layers according to the configuration or indication of the first information.

In some embodiments, in the operation 501, the network device may inform the terminal equipment of an available AI/ML model via the first information. In the operation 502, the terminal equipment may perform channel estimation by using an existing method, relevant technologies may be referred to, and description is omitted here.

In the above embodiment, in the operation 502, the terminal equipment may feedback CSI of two or more layers to the network device by using unequal numbers of bits according to the configuration or indication of the first information and the consensus reached with the network device (the first rule).

In the above embodiments, a pre-agreed item, i.e., the first rule (known to both the terminal equipment and the network device, and containing the standard document) includes: a serial number of an AI/ML model; a criterion for selecting an AI/ML model; a feedback order of an CSI vector; and how does a network device read CSI. Specific steps are listed as follows:
S1: the network device configures four available AI/ML models for the terminal equipment, arranges the number of output bits of these four AI/ML models in a descending order, and gives serial numbers 1, 2, 3, 4;
S2: the network device transmits a CSI-RS;
S3: the terminal equipment receives the CSI-RS, measures a spatial channel, calculates a rank of a spatial channel matrix to be 2, and calculates a singular value of the spatial channel matrix to be σₖ, k=1,2, and there is σ₁>σ₂>0;
S4: for singular vectors corresponding to the above two singular values, the terminal equipment selects two models with the largest number of feedback bits among the four AI/ML models, namely model 1 and model 2, according to the standard regulations, and assigns model 1 to a singular vector corresponding to σ₂, and assigns model 2 to a singular vector corresponding to σ₁;
S5: the terminal equipment compresses the two singular vectors by using a determined AI/ML model;
S6: the terminal equipment feeds back the two compressed vectors to the network device in an order of σ₁>σ₂;
S7: according to the received compressed vectors, the network device selects a reconstruction part of an appropriate AI/ML model for decompression according to the provisions of the Standard Text, and generates a precoding matrix;
S8: the network device transmits data to the terminal equipment by using the precoding matrix.

In the S7, according to the first rule, the network device knows which two AI/ML models are used by the terminal equipment, and the number of bits outputted by each AI/ML model.

In some other embodiments, in the operation 501, the network device informs the terminal equipment that only one pre-agreed AI/ML model may be used. The number of bits outputted by this AI/ML model is generally not less than the number of bits corresponding to a layer with the maximum number of feedback bits specified in the Standard Text. At this moment, for different vectors of a spatial channel matrix, since the same AI/ML model is used, thus the number of bits outputted is the same. A truncation operation is performed on outputs of AI/ML further according to the number of feedback bits of each vector specified in the Standard Text.

In the above embodiment, in the operation 502, the terminal equipment receives a CSI-RS, performs channel estimation by using an existing method, generates and feeds back CSI according to configuration information of the network device, for example according to an indication of a base station and the provisions of the Standard Text, wherein the terminal equipment may use different processing methods for CSI of two or more layers.

In the above embodiments, a pre-agreed item, i.e., the first rule (known to both the terminal equipment and the network device, and containing the standard document) includes: an AI/ML model; a criterion and/or method for truncating a CSI vector; a feedback order of a CSI vector; how does a network device read CSI, and a method for lengthening a truncated CSI vector. Specific steps are listed as follows:
S1: a network device configures an available AI/ML model for a terminal equipment, such as AI/ML model A;
S2: the network device transmits a CSI-RS;
S3: the terminal equipment receives the CSI-RS, measures a spatial channel, calculates a rank of a spatial channel matrix to be 3, and calculates a singular value of the spatial channel matrix to be σₖ, k=1,2,3, and there is σ₁>σ₂>σ₃>0, and singular vectors corresponding to these three singular values;
S4: the terminal equipment processes said three singular vectors using the AI/ML model A configured by the network device, for example performing compression;
S5: the terminal equipment reprocesses a processed result according to the provisions of a standard document;

For example, in a case where a length of a bit sequence of the processed result is longer than a length of a bit sequence specified in the Standard, the bit sequence of the processed result is truncated, a method for truncation includes but is not limited to:
deleting a corresponding backmost bit; or
performing IDFT on a bit sequence that need to be truncated, deleting a component at a predetermined position, and performing DFT on an obtained sequence.

For another example, when the length of the bit sequence of the processed result is the same as the length of the bit sequence specified in the Standard, no operation is performed.
S6: the terminal equipment feeds back these three reprocessed vectors to the network device in an order of σ₁>σ₂>σ₃;
S7: the network device calculates an original length of each singular vector according to the provisions of the Standard Text and the number of bits outputted by an AI/ML model that is configured by the network device and that the terminal equipment should use;
S8: the network device performs data post-processing according to the received reprocessed vectors and according to the original lengths of the singular vectors calculated in the previous step;

For example, in a case where the length of the bit sequence of the result obtained by the terminal equipment in the S4 is longer than the length of the bit sequence specified in the Standard, since the terminal equipment has already performed a truncation operation on the result in the S5, the network device may perform a corresponding lengthening operation, for example:
adding 0 to the corresponding backmost bit; or
performing IDFT on a bit sequence that needs to be lengthened, adding 0 at a pre-specified position, then performing DFT on an obtained sequence.

For another example, in a case where the length of the bit sequence of the result obtained by the terminal equipment in the S4 is the same as the length of the bit sequence specified in the Standard, since the terminal equipment does not perform a truncation operation, accordingly, the network device does not perform any operation either.

S9: the network device uses a reconstruction part of the AI/ML model to perform spatial channel recovery for the post-processing result in the previous step, and generates a precoding matrix;
S10: the network device transmits data to the terminal equipment by using the precoding matrix.

In the S7, according to the first rule, the network device knows which AI/ML model is used by the terminal equipment, and the number of bits outputted by this AI/ML model.

FIG. 6 is a schematic diagram of another example of a method in the embodiments of the present disclosure. As shown in FIG. 6, the method includes:
601: a network device switches to a CSI unequal bit feedback mode, allocation of the number of bits is determined by a terminal equipment and is reported to the network device;
602: the terminal equipment feeds back CSI according to configuration of the network device, which contains a bit number allocation method.

In the embodiments of the present disclosure, in the operation 601, the network device transmits a CSI-RS to the terminal equipment, and via the first information, configures or indicates the terminal equipment to feedback CSI of at least two layers of the CSI of N layers (N≥2) by using unequal numbers of bits, and the number of feedback bits of CSI of each layer is determined by the terminal equipment and is reported to the network device; wherein the total number of feedback bits may be configured by the network device or may be specified in the Standard. In the operation 602, the terminal equipment receives the CSI-RS, performs channel estimation, and generates and feeds back the CSI of the N layers according to the configuration or indication of the first information.

In the above embodiment, in the operation 602, the terminal equipment, according to an indication of the network device, selects one of several possibilities of unequal numbers of feedback bits agreed in advance, then feeds back CSI of at least two layers to the network device by using unequal numbers of bits, and feeds back the method of unequal numbers of feedback bits used by it to the network device.

In the above embodiments, a pre-agreed item, i.e., the first rule (known to both the terminal equipment and a base station, and containing the standard document) includes: a method for approximating the number of feedback bits; a serial number of an AI/ML model; a criterion for selecting an AI/ML model; a feedback order of an CSI vector; how does a network device read CSI; and the number of bits outputted by each AI/ML model. Specific steps are listed as follows:
S1: the network device transmits a CSI-RS; The network device may configure and notify that the transport layer of CSI is 2 and the total number of feedback bits is 90 bits.

S2: a terminal receives the CSI-RS, measures a spatial channel, calculates a rank of a spatial channel matrix to be 3, and calculates a singular value of the channel matrix to be σₖ, k=1,2,3, and there is σ₁>σ₂>σ₃>0, σ₁²=1.237962;

According to the configuration of the network device, the terminal equipment selects two largest singular values, and singular vectors (σ₁>σ₂) corresponding to them;
S3: for the singular vectors corresponding to the above two singular values, the terminal equipment assigns the number of feedback bits according to the total number of feedback bits and an unequal ratio α₁²=1.2379σ₂², respectively being 1.2379÷2.2379×90=49.78, 1÷2.2379×90=40.21;
S4: the terminal equipment approximates (quantifies) the number of feedback bits to obtain results being 50 bits and 40 bits respectively;
S5: for the above two singular vectors, the terminal equipment performs compression by using a determined or selected AI/ML model according to the approximate number of feedback bits;

Each pair of AI/ML models corresponds to a number of feedback bits. Assuming that the network device and the terminal equipment agree that there are 8 pairs of AI/ML models in total, the number of their feedback bits are 24 bits, 30 bits, 36 bits, 42 bits, 48 bits, 54 bits, 60 bits and 660 bits respectively, and corresponding indexes or identifiers or serial numbers of AI/ML models are 000, 001, 010, 011, 100, 101, 110, 111, respectively.

A criterion for the terminal equipment to determine or select an AI/ML model may be: an AI/ML model of which the approximation of the number of feedback bits calculated by the terminal equipment is closest to the existing AI/ML model. In the above embodiment, a layer corresponding to σ₁ is expected to feedback 50 bits and an AI/ML model that feeds back 48 bits (i.e., an AI/ML model with an index being 100) is used, and a layer corresponding to σ₂ is expected to feedback 40 bits and an AI/ML model that feeds back 42 bits (i.e., an AI/ML model with an index being 011) is used.

S6: the terminal equipment feeds back the two compressed vectors and indexes of an AI/ML model, i.e., 100 and 011 respectively, to the network device in an order of σ₁>σ₂;
S7: the network device performs decompression according to indexes of the AI/ML model and the received compressed vectors, and generates a precoding matrix;
S8: the network device transmits data to the terminal equipment by using the precoding matrix.

In the S7, the network device knows the AI/ML model used by the terminal equipment and the number of bits outputted by the AI/ML model according to the index of the AI/ML model fed back by the terminal equipment. In addition, a feedback order of CSI (compressed vectors) may be specified in the Standard, that is, the network device may further determine a feedback order of compressed vectors (CSI) fed back by the terminal equipment according to the provisions of the Standard, and thereby receives corresponding CSI. The present disclosure is not limited to this. The feedback order of CSI may further be agreed upon by the network device and the terminal equipment, and the present disclosure does not restrict a mode of agreement.

It should be noted that the above examples schematically describe the embodiments of the present disclosure only by taking generation of CSI of N layers (N≥2) based on an AI/ML model as an example, however the present disclosure is not limited to this. For example, an execution step of each operation may be adjusted appropriately, moreover other some operations may be increased or operations therein may be reduced. Persons skilled in the art may make appropriate modifications according to the above contents, not limited to the records in the above examples.

The method in the embodiments of the present disclosure will be described below by taking “a terminal equipment generates the above channel state information of N layers based on a codebook” as an example.

In the embodiments of the present disclosure, a terminal equipment may receive first configuration information transmitted by a network device, the first configuration information being used for configuring the terminal equipment with value ranges of wideband amplitudes, value ranges of subband amplitudes and value ranges of phase combining coefficients to which the channel state information of at least two layers corresponds respectively, wherein at least one of the value ranges of wideband amplitudes, the value ranges of subband amplitudes and the value ranges of phase combining coefficients to which the channel state information of at least two layers corresponds respectively is different.

For example, the value ranges of wideband amplitudes to which the channel state information of at least two layers corresponds respectively are different, and/or, the value ranges of subband amplitudes to which the channel state information of at least two layers corresponds respectively are different, and/or, the value ranges of phase combining coefficients to which the channel state information of at least two layers corresponds respectively are different. That is, CSI of at least two layers in the CSI of N layers is indicated by unequal numbers of bits by “at least one of the value ranges of wideband amplitudes, the value ranges of subband amplitudes and the value ranges of phase combining coefficients to which the channel state information of at least two layers corresponds respectively is different”.

In the above embodiments, implementations of the first configuration information are not restricted, for example, the first configuration information may be included in RRC signaling transmitted by a network device to a terminal equipment or in high-layer signaling. For details, relevant technologies may be referred to.

In the above embodiments, the CSI is generated based on a codebook, the CSI may include PMI which may include wideband information or include wideband information and subband information.

The wideband information includes: beam offset of a 2D oversampled DFT beam; a beam selected from a set of beams determined according to the beam offset of the 2D oversampled DFT beam; an index corresponding to a maximum amplitude beam; and a wideband amplitude; the subband information includes: a phase combining coefficient and a subband amplitude.

In the above embodiments, as described above, at least one of the value ranges of wideband amplitudes, the value ranges of subband amplitudes and the value ranges of phase combining coefficients to which the CSI of at least two layers corresponds respectively is different. That is, the value ranges of wideband amplitudes to which the CSI of at least two layers corresponds respectively are the same or different; the value ranges of phase combining coefficients to which the CSI of at least two layers corresponds respectively are the same or different; the value ranges of subband amplitudes to which the CSI of at least two layers corresponds respectively are the same or different.

The method in the embodiments of the present disclosure in a case of generating CSI based on a codebook is illustrated below in conjunction with specific examples.

In some embodiments, the type II codebook is taken into account, and there are two transport layers. According to the method in the embodiments of the present disclosure, the following codebook design may be adopted.

In this embodiment, assuming that RI is 2, and for singular values (eigenvalues) of a spatial channel matrix, there is σ₁>σ₂, right singular vectors (eigenvectors) corresponding to these two singular values are v₁ and v₂, respectively. In this embodiment, for a layer with the larger singular value, feedback is performed using a smaller number of bits relative to the other layer.

In this embodiment, a network device may configure the following parameters for a terminal equipment:

1. Parameters N₁ and N₂2:

The above parameters are configured by a higher layer, optional configurations and the selection of corresponding oversampling coefficients O₁ and O₂ are shown in Table 5.2.2.2.1-2. The number (P_{CSI-RS}) of CSI-RS ports is 2N₁N₂.

TABLE 5.2.2.2.1-2
supported configurations of (N₁, N₂) and (O₁, O₂)

| The number of CSI-RS antenna ports, | | |
|---|---|---|
| P_{CSI-RS} | (N₁, N₂) | (O₁, O₂) |
| 4 | (2, 1) | (4, 1) |
| 8 | (2, 2) | (4, 4) |
| | (4, 1) | (4, 1) |
| 12 | (3, 2) | (4, 4) |
| | (6, 1) | (4, 1) |
| 16 | (4, 2) | (4, 4) |
| | (8, 1) | (4, 1) |
| 24 | (4, 3) | (4, 4) |
| | (6, 2) | (4, 4) |
| | (12, 1) | (4, 1) |
| 32 | (4, 4) | (4, 4) |
| | (8, 2) | (4, 4) |
| | (16, 1) | (4, 1) |

### 2. Parameter L:

The above parameter is configured by a higher layer, when P_{CSI-RS}=4, L=2; when P_{CSI-RS}>4, L∈{2,3,4}.

### 3. Parameter N_{PSK}:

The above parameter is configured by a higher layer, and may have different value ranges for different transport layers, denoted as N_{PSK,l}: l=1, 2, . . . v, where v is a value of RI. One example is: N_{PSK,1} ∈{4,8}, N_{PSK,2} ∈{4,16}.

### 4. Whether to Use a Subband Amplitude:

The above parameter is configured by a higher layer, its value may be true or false.

### 5. RI Reported by a Terminal Equipment:

The above parameter does not exceed 2. v is denoted as RI reported by the terminal equipment, each PMI value corresponds to indexes i₁ and i₂ of a codebook, where,

$${i}_{1} = \{ \begin{matrix}[ \begin{matrix}{i}_{1 , 1} & {i}_{1 , 2} & {i}_{1 , 3 , 1} & {i}_{1 , 4 , 1}\end{matrix} ] & v = 1 \\ [ \begin{matrix}{i}_{1 , 1} & {i}_{1 , 2} & {i}_{1 , 3 , 1} & {i}_{1 , 4 , 1} & {i}_{1 , 3 , 2} & {i}_{1 , 4 , 2}\end{matrix} ] & v = 2\end{matrix}$$

$${i}_{2} = \{ \begin{matrix}[ {i}_{2 , 1 , 1} ] & subbandAmplitude = ‘ false ’ , v = 1 \\ [ \begin{matrix}{i}_{2 , 1 , 1} & {i}_{2 , 1 , 2}\end{matrix} ] & subbandAmplitude = ‘ false ’ , v = 2 \\ [ \begin{matrix}{i}_{2 , 1 , 1} & {i}_{2 , 2 , 1}\end{matrix} ] & subbandAmplitude = ‘ true ’ , v = 1 \\ [ \begin{matrix}{i}_{2 , 1 , 1} & {i}_{2 , 2 , 1} & {i}_{2 , 1 , 2} & {i}_{2 , 2 , 2}\end{matrix} ] & subbandAmplitude = ‘ true ’ , v = 2\end{matrix}$$

In the above embodiments, a situation in which v=2 and a subband amplitude (true) is used is taken into account. According to a standard definition of an existing standard, at this moment, two transport layers both use wideband reporting and subband reporting. Parameters needing to be reported are as follows:

$${i}_{1} = [ \begin{matrix}{i}_{1 , 1} & {i}_{1 , 2} & {i}_{1 , 3 , 1} & {i}_{1 , 4 , 1} & {i}_{1 , 3 , 2} & {i}_{1 , 4 , 2}\end{matrix} ]$$

$${i}_{2} = [ \begin{matrix}{i}_{2 , 1 , 1} & {i}_{2 , 2 , 1} & {i}_{2 , 1 , 2} & {i}_{2 , 2 , 2} ]\end{matrix}$$

In the above embodiments, contents reported by the terminal equipment for i₁ and i₂ are given by the process of the existing standard. Physical meaning of each parameter is described as follows:
1) i_{1,1}: wideband reporting, which is beam offset of a 2D oversampled DFT beam, there are O₁O₂ possibilities in total, thus ┌log₂ O₁O₂┐ bits are needed for reporting.
2) i_{1,2}: wideband reporting, the beam offset i_{1,1} selected in the last step determines a beam set consisting of N₁N₂ beams. i_{1,2} represents that L beams are selected from the N₁N₂ beams, there are (^{N}^{₂}_{L}^{N}^{₂}) possibilities in total, thus ┌log₂(^{N}^{₂}_{L}^{N}^{₂})┐bits are needed for reporting.
3) i_{1,3,l}: wideband reporting, which represents an index corresponding to the lth layer maximum amplitude beam, there are 2L possibilities in total, thus ┌log₂(2L)┐ bits are needed for reporting.
4) i_{1,4,l}: wideband reporting, which represents a wideband amplitude.

Being different from the possibilities of a total of 8 wideband amplitudes specified in the existing standard, in this embodiment, the number of bits required for wideband amplitudes of two layers may be unequal. Possible wideband amplitudes are given in the following Table 5.2.2.2.3-2a and Table 5.2.2.2.3-2b. (Excluding the largest amplitude beam) there are a total of 2L−1 wideband amplitudes needing to be fed back, thus the first layer needs (2L−1) log₂ 4=2(2L−1) bits for reporting, and the second layer needs (2L−1) log₂ 16=4(2L−1) bits for reporting.

TABLE 5.2.2.2.3-2a
mapping of elements of i_{1,4,l}: k_{l,i}⁽¹⁾ to p_{l,i}⁽¹⁾

| k_{l,i}⁽¹⁾ | p_{l,i}⁽¹⁾ |
|---|---|
| 0 | 0 |
| 1 | $\sqrt{1 / 4}$ |
| 2 | $\sqrt{1 / 2}$ |
| 3 | 1 |

TABLE 5.2.2.2.3-2b
mapping of elements of i_{1,4,l}: k_{l,i}⁽¹⁾ to p_{l,i}⁽¹⁾

| k_{l,i}⁽¹⁾ | p_{l,i}⁽¹⁾ |
|---|---|
| 0 | 0 |
| 1 | $\sqrt{1 / 128}$ |
| 2 | $\sqrt[4]{1 / 8192}$ |
| 3 | $\sqrt{1 / 64}$ |
| 4 | $\sqrt[4]{1 / 2048}$ |
| 5 | $\sqrt{1 / 32}$ |
| 6 | $\sqrt[4]{1 / 512}$ |
| 7 | $\sqrt{1 / 16}$ |
| 8 | $\sqrt[4]{1 / 128}$ |
| 9 | $\sqrt{1 / 8}$ |
| 10 | $\sqrt[4]{1 / 32}$ |
| 11 | $\sqrt{1 / 4}$ |
| 12 | $\sqrt[4]{1 / 8}$ |
| 13 | $\sqrt{1 / 2}$ |
| 14 | $\sqrt[4]{1 / 2}$ |
| 15 | 1 |

5) i_{2,1,l}, l=1,2, . . . v (v=2): subband reporting, which represents a phase combining coefficient.

Being different from the existing standard, sizes of value ranges (alphabet) of the phase combining coefficient φ_{l,i} of each layer in this embodiment is unequal, i.e., N_{PSK,1}≠N_{PSK,2}. In this embodiment, N_{PSK,1}∈{4,8}, N_{PSK,2}∈{4,8,16}. A value of the phase combining coefficient φ_{l,i} is taken as follows:

$${φ}_{l , i} = \{ \begin{matrix}{e}^{j 2 π {c}_{l , i} / {N}_{PSK , l}} , & subbandAmplitude = ‘ false ’ \\ {e}^{\frac{j 2 π {c}_{l , i}}{{N}_{PSK , l}}} , & subbandAmplitude = ‘ true ’ , min ( {M}_{l} , {K}^{( 2 )} ) \\ & strongest coefficients ( including {i}_{1 , 3 , l} ) with {k}_{l , i}^{( 1 )} > 0 \\ {e}^{j 2 π {c}_{l , i} / 4} , & subbandAmplitude = ‘ true ’ , {M}_{l} - min ( {M}_{l} , {K}^{( 2 )} ) \\ & weakest coefficients with {k}_{l , i}^{( 1 )} > 0 \\ 1 , & subbandAmplitude = ‘ true ’ , \\ & 2 L - {M}_{l} coefficients with {k}_{l , i}^{( 1 )} = 0\end{matrix}$$

where, each layer (the l th layer) needs min(Mₗ, K⁽²⁾) log₂ N_{PSK,l}+2(Mₗ−min(Mₗ, K⁽²⁾))−log₂ N_{PSK,l} bits for reporting, wherein Mₗ is the number of i_{1,4,l} satisfying k_{l,i}⁽¹⁾>0. For values of K⁽²⁾, please see the following table 5.2.2.2.3-4:

Table 5.2.2.2.3-4: full-resolution subband coefficients when subbandAmplitude is set to be “true”

| L | K⁽²⁾ |
|---|---|
| 2 | 4 |
| 3 | 4 |
| 4 | 6 |

6) i_{2,2,l}, l=1,2, . . . v (v=2): subband reporting, which represents a subband amplitude.

The existing standard stipulates that only min(M₁, K⁽²⁾)−1 strongest amplitude beams have subband amplitude reporting. Being different from 3GPP 38.214, sizes of value ranges of subband amplitudes of each layer in this embodiment may be unequal. In this embodiment, possible subband amplitudes are given in the following Table 5.2.2.2.3-3 and Table 5.2.2.2.3-3b, min(M₁, K⁽²⁾)−1+2(min(M₂, K⁽²⁾)−1) bits in total are needed for reporting.

TABLE 5.2.2.2.3-3
mapping of elements of i_{2,2,l}: k_{l,i}⁽²⁾ to p_{l,i}⁽²⁾

| k_{l,i}⁽²⁾ | p_{l,i}⁽²⁾ |
|---|---|
| 0 | $\sqrt{\frac{1}{2}}$ |
| 1 | 1 |

TABLE 5.2.2.2.3-3b
mapping of elements of i_{2,2,l}: k_{l,i}⁽²⁾ to p_{l,i}⁽²⁾

| k_{l,i}⁽²⁾ | p_{l,i}⁽²⁾ |
|---|---|
| 0 | $\sqrt{1 / 8}$ |
| 1 | $\sqrt{1 / 4}$ |
| 2 | $\sqrt{1 / 2}$ |
| 3 | 1 |

In summary, the total number of feedback bits required in this embodiment is:

$$⌈ {log}_{2} {O}_{1} {O}_{2} ⌉ + ⌈ {log}_{2} ( \begin{matrix}{N}_{1} {N}_{2} \\ L\end{matrix} ) ⌉ + 2 ⌈ {log}_{2} ( 2 L ) ⌉ + 6 ( 2 L - 1 ) + {\sum }_{l = 1}^{2} ( min ( {M}_{l} , {K}^{( 2 )} ) {log}_{2} {N}_{PSK , l} + 2 ( {M}_{l} - min ( {M}_{l} , {K}^{( 2 )} ) ) - {log}_{2} {N}_{PSK , l} ) + min ( {M}_{1} , {K}^{( 2 )} ) - 1 + 2 ( min ( {M}_{2} , {K}^{( 2 )} ) - 1 )$$

For example, (N₁, N₂)=(8,1) is selected, then from Table 5.2.2.2.1-2, (O₁, O₂)=(4,1). L=4 is selected, then from Table 5.2.2.2.3-4, K⁽²⁾=6. N_{PSK,1}=4, N_{PSK,2}=8, M₁=5, M₂=5, according to the above formula, the total number of feedback bits is also 89 bits.

According to the method in this embodiment, compared with existing methods, the number of feedback bits in the method of this embodiment is also 89 bits. However, compared with related arts, by using the method in this embodiment, for wideband amplitudes, subband amplitudes and combining phases of two transport layers, unequal numbers of bits are used for reporting, such that different feedback accuracy is achieved. That is, on the premise that the total number of feedback bits is equal, in the embodiments of the present disclosure, unequal numbers of bits are used for reporting for at least two layers, so that for a layer with a large singular value, less bits are used for reporting, and for a layer with a small singular value, more bits are used for reporting.

In some other embodiments, the type II codebook is still taken into account, but being different from the previous embodiment, subband reporting is false.

In this embodiment, assuming that RI is 2, and for singular values (eigenvalues) of a spatial channel matrix, there is σ₁>σ₂, right singular vectors (eigenvectors) corresponding to these two singular values are v₁ and v₂, respectively. In this example, for a layer with the larger singular value, feedback is performed using a smaller number of bits relative to the other layer.

In this embodiment, a network device may configure the following parameters for a terminal equipment:

1. Parameters N₁ and N₁:

The above parameters are configured by a higher layer, optional configurations and the selection of corresponding oversampling coefficients O₁ and O₂ are shown in Table 5.2.2.2.1-2. The number (P_{CSI-RS}) of CSI-RS ports is 2N₁N₂.

### 2. Parameter L:

The above parameter is configured by a higher layer, when P_{CSI-RS}=4, L=2; when P_{CSI-RS}>4, L∈{2,3,4}.

### 3. Parameter N_{PSK}:

The above parameter is configured by a higher layer.

### 4. Whether to Use a Subband Amplitude:

The above parameter is configured by a higher layer, its value may be true or false.

### 5. RI Reported by a Terminal Equipment:

The above parameter does not exceed 2. v is denoted as RI reported by the terminal equipment, each PMI value corresponds to indexes i₁ and i₂ of a codebook, where,

$${i}_{1} = \{ \begin{matrix}[ \begin{matrix}{i}_{1 , 1} & {i}_{1 , 2} & {i}_{1 , 3 , 1} & {i}_{1 , 4 , 1}\end{matrix} ] & v = 1 \\ [ \begin{matrix}{i}_{1 , 1} & {i}_{1 , 2} & {i}_{1 , 3 , 1} & {i}_{1 , 4 , 1} & {i}_{1 , 3 , 2} & {i}_{1 , 4 , 2}\end{matrix} ] & v = 2\end{matrix}$$

$${i}_{2} = \{ \begin{matrix}[ {i}_{2 , 1 , 1} ] & subbandAmplitude = ‘ false ’ , v = 1 \\ [ \begin{matrix}{i}_{2 , 1 , 1} & {i}_{2 , 1 , 2}\end{matrix} ] & subbandAmplitude = ‘ false ’ , v = 2 \\ [ \begin{matrix}{i}_{2 , 1 , 1} & {i}_{2 , 2 , 1}\end{matrix} ] & subbandAmplitude = ‘ true ’ , v = 1 \\ [ \begin{matrix}{i}_{2 , 1 , 1} & {i}_{2 , 2 , 1} & {i}_{2 , 1 , 2} & {i}_{2 , 2 , 2}\end{matrix} ] & subbandAmplitude = ‘ true ’ , v = 2\end{matrix}$$

In the above embodiments, a situation in which v=2 and a subband amplitude (false) is used is taken into account. According to a standard definition of an existing standard, at this moment, two transport layers both use a subband amplitude. Parameter needing to be reported is as follows:

$${i}_{1} = [ \begin{matrix}{i}_{1 , 1} & {i}_{1 , 2} & {i}_{1 , 3 , 1} & {i}_{1 , 4 , 1} & {i}_{1 , 3 , 2} & {i}_{1 , 4 , 2}\end{matrix} ]$$

In the above embodiments, contents reported by the terminal equipment for i₁ are given by the process of the existing standard. Physical meaning of each parameter is described as follows:
1) i_{1,1}: wideband reporting, which is beam offset of a 2D oversampled DFT beam, there are O₁O₂ possibilities in total, thus ┌log₂ O₁O₂┐ bits are needed for reporting.
2) i_{1,2}: wideband reporting, the beam offset i_{1,1} selected in the last step determines a beam set consisting of N₁N₂ beams. i_{1,2} represents that L beams are selected from the N₁N₂ beams, there are (^{N}^{₂}_{L}^{N}^{₂}) possibilities in total, thus ┌log₂(^{N}^{₂}_{L}^{N}^{₂})┐bits are needed for reporting.
3) i_{1,3,l}: wideband reporting, which represents an index corresponding to the lth layer maximum amplitude beam, there are 2L possibilities in total, thus ┌log₂(2L)┐ bits are needed for reporting.
4) i_{1,4,l}: wideband reporting, which represents a wideband amplitude.

Being different from the possibilities of a total of 8 wideband amplitudes specified in the existing standard, in this embodiment, the number of bits required for wideband amplitudes of at least two layers may be unequal. Possible wideband amplitudes are given in the Table 5.2.2.2.3-2a and Table 5.2.2.2.3-2b. (Excluding the largest amplitude beam) there are a total of 2L−1 wideband amplitudes needing to be fed back, thus the first layer needs (2L−1) log₂ 4=2(2L−1) bits for reporting, and the second layer needs (2L−1) log₂ 16=4(2L−1) bits for reporting.

In summary, the total number of feedback bits required in this embodiment is:

$$⌈ {log}_{2} {O}_{1} {O}_{2} ⌉ + ⌈ {log}_{2} ( \begin{matrix}{N}_{1} {N}_{2} \\ L\end{matrix} ) ⌉ + 2 ⌈ {log}_{2} ( 2 L ) ⌉ + 6 ( 2 L - 1 )$$

For example, (N₁, N₂)=(8,1) is selected, then from Table 5.2.2.2.1-2, (O₁, O₂)=(4,1). L=4 is selected, then according to the above formula, the total number of feedback bits is 57 bits. In this embodiment, although the total number of feedback bits is equal to the total number of feedback bits calculated according to an existing standard, the wideband reporting accuracy of two transport layers is different, and the two layers feedback unequal numbers of bits.

It should be noted that the above examples schematically describe the embodiments of the present disclosure only by taking generating CSI of N layers (N≥2) based on a codebook as an example, however the present disclosure is not limited to this. The network device may further configure other parameters for the terminal equipment or reduce configuration of certain parameters. Persons skilled in the art may make appropriate modifications according to the above contents, not limited to the records in the above examples.

In the embodiments of the present disclosure, the network device may further indicate the terminal equipment to report parameters fed back by CSI according to reportQuatity specified by the network device.

In the above embodiment, the terminal equipment receives second configuration information transmitted by the network device, the second configuration information including reportQuatity needing to be fed back, the reportQuatity needing to be fed back including at least one of the following: the number of feedback bits of the channel state information of at least two layers, and indices or serial numbers or identifiers of AI/ML models respectively used by the channel state information of at least two layers.

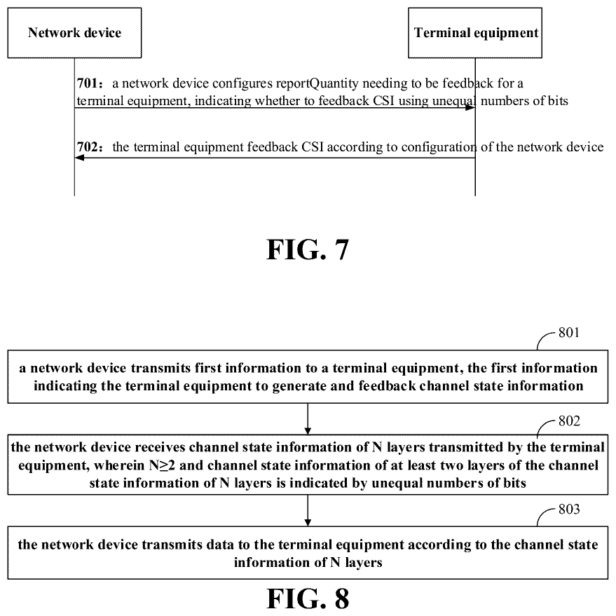

FIG. 7 is a schematic diagram of a further example of a method in the embodiments of the present disclosure. As shown in FIG. 7, the method includes:
701: a network device configures reportQuantity needing to be fed back for a terminal equipment, indicating whether to feedback CSI using unequal numbers of bits;
702: the terminal equipment feeds back CSI according to configuration of the network device.

In the embodiments of the present disclosure, in the operation 701, the network device transmits a CSI-RS to the terminal equipment, and via the first information, configures or indicates the terminal equipment to report parameters fed back by the channel state information according to reportQuantity specified by the network device; in the operation 702, the terminal equipment receives the CSI-RS, performs channel estimation, and generates and feeds back the CSI of the N layers according to the configuration or indication of the first information.

In some embodiments, in the operation 701, reportQuantity includes whether to feedback CSI of two or more layers using unequal numbers of bits. If feedback is performed using unequal numbers of bits, the number of bits specifically fed back by CSI of each layer is executed, as specified in the standard text.

In the above embodiment, in the operation 702, the terminal equipment decides to feedback CSI of different layers using equal or unequal numbers of bits, and reports it to the network device.

It should be noted that the above examples only schematically describe reportQuatity needing to be fed back, however the present disclosure is not limited to this. reportQuatity needing to be fed back may further include other contents. Persons skilled in the art may make appropriate modifications according to the above contents, not limited to the records in the above examples.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

According to the method in the embodiments of the present disclosure, unequal numbers of feedback bits are allocated to two or more subchannels, that is, different feedback precisions are used for two or more subchannels, thus a system gain is improved. Moreover, compared with traditional codebook methods, the feedback precision is further improved.

### Embodiments of a Second Aspect

The embodiments of the present disclosure provide a data transmission method, which will be described from a network device side. The method relates to processing at a network side corresponding to the method in the embodiments of the first aspect, wherein the same contents as the embodiments of the first aspect are not repeated.

FIG. 8 is a schematic diagram of a data transmitting method in the embodiments of the present disclosure. As shown in FIG. 8, the method includes:
801: a network device transmits first information to a terminal equipment, the first information indicating the terminal equipment to generate and feedback channel state information;
802: the network device receives channel state information of N layers transmitted by the terminal equipment, wherein N≥2 and channel state information of at least two layers of the channel state information of N layers is indicated by unequal numbers of bits; and
803: the network device transmits data to the terminal equipment according to the channel state information of N layers.

In the operation 803, the network device may generate a precoding matrix according to the channel state information of N layers, process the precoding matrix to data transmitted by the network device to the terminal equipment, and transmit the data after being processed by the precoding matrix to the terminal equipment. For a specific transmission process, relevant technologies may be referred to, and a description thereof is omitted here.

In the embodiments of the present disclosure, the channel state information of N layers may be generated by the terminal equipment based on a codebook, or may be generated by the terminal equipment based on an AI/ML model.

The method in the embodiments of the present disclosure will be described below by taking “a terminal equipment generates the above channel state information of N layers (N≥2) based on an AI/ML model” as an example.

In some embodiments, the first information includes a first rule, i.e., the network device configures the first rule for the terminal equipment, the first rule refers to a rule that indicates the channel state information of at least two layers using unequal numbers of bits. Or, the first rule is predefined or preconfigured.

In the above embodiment, the first rule may include but is not limited to one of the following or a combination thereof:
an available AI/ML model;
a criterion and/or method for selecting an AI/ML model;
a criterion and/or method for truncating CSI;
a method for approximating the number of feedback bits;
a maximum number of downlink transmission layers;
a maximum total number of feedback bits; and
a feedback order of CSI.

In some embodiments, in the first rule, the number of the available AI/ML models is one or more.

In some embodiments, in the first rule, the criterion and/or method for truncating CSI include(s):
if a length of a bit sequence of the CSI is greater than a specified length of a bit sequence, a truncation operation is performed on the bit sequence of the CSI;
if the length of the bit sequence of the CSI is the same as the specified length of the bit sequence, the bit sequence of the CSI is retained.

The truncation operation may be performed on the bit sequence of the CSI according to a second rule that is predefined or preconfigured or configured by a network device, the second rule here includes but is not limited to:
removing a component at a first position in the bit sequence of the CSI, so that a length of the obtained bit sequence of the CSI is the same as a specified length of a bit sequence, wherein the first position is one or more bits of any positions in the bit sequence of the CSI, or,
performing IDFT operation on the bit sequence of the CSI, remove a component at a second position in the bit sequence of the CSI, and perform DFT operation on an obtained bit sequence, so that a length of the obtained bit sequence of the CSI is the same as a specified length of a bit sequence, wherein the second position is one or more bits of any positions in the bit sequence of the CSI.

In some embodiments, in the first rule, the feedback order of CSI includes an order of values corresponding to CSI from large to small, or an order of the values corresponding to CSI from small to large, or other order agreed upon by a network device and a terminal equipment. The values corresponding to CSI may be eigenvalues or singular values of a spatial channel matrix.

In some embodiments, the AI/ML model is a two-sided AI/ML model or a one-sided AI/ML model, the two-sided AI/ML model refers to that the AI/ML model is provided at a network device side and a terminal equipment side; and the one-sided AI/ML model refers to that the AI/ML model is provided at the network device side or the terminal equipment side.

In some embodiments, if the number of available AI/ML models is more than one, the network device recovers received channel state information using a corresponding AI/ML model according to the available AI/ML model and a criterion and/or method for selecting the AI/ML model.

In some embodiments, if the number of available AI/ML models is one, the network device performs post-processing on the received channel state information based on the first rule, and recovers the post-processed channel state information.

In some embodiments, the network device may further receive indication information from the terminal equipment, the indication information indicating a serial number or index or identifier of an AI/ML model used by the channel state information, the network device may perform post-processing on the received channel state information according to the serial number or index or identifier of the AI/ML model used by the channel state information, and recovers the post-processed channel state information.

In each of the above embodiments, the post-processing may include:
if a length of a bit sequence of CSI processed by a terminal equipment is greater than a specified length of a bit sequence, since the terminal equipment performs a truncation operation on the processed CSI, the network device may determine a corresponding lengthening mode according to the criterion and/or method for truncating CSI contained in the first rule, and perform a lengthening operation on the received bit sequence of CSI;
if a length of a bit sequence of CSI processed by a terminal equipment is the same as a specified length of a bit sequence, since the terminal equipment does not perform a truncation operation on the processed CSI, the network device does not perform a corresponding lengthening operation on the received CSI, but retains the bit sequence of the CSI.

In the above embodiment, performing a lengthening operation on the bit sequence of the CSI according to the first rule may include:
supplementing 0 or 1 or a sequence generated according to a predefined rule to a corresponding bit in a first position; or
performing IDFT operation on a bit sequence needing to be lengthened, supplementing 0 or 1 or a sequence generated according to a predefined rule to a corresponding bit in a second position, then performing DFT operation on an obtained sequence.

The method in the embodiments of the present disclosure will be described below by taking “a terminal equipment generates the above channel state information of N layers (N≥2) based on a codebook” as an example.

The network device may further configure the terminal equipment with value ranges of wideband amplitudes, value ranges of subband amplitudes and value ranges of phase combining coefficients to which the channel state information of at least two layers corresponds respectively, wherein at least one of the value ranges of wideband amplitudes, the value ranges of subband amplitudes and the value ranges of phase combining coefficients to which the channel state information of at least two layers corresponds respectively is different.

In some embodiments, the channel state information includes PMI that includes wideband information (e.g. i₁) or includes wideband information (e.g. i₁) and subband information (e.g. i₂). The wideband information (e.g. i₁) includes: beam offset (e.g. i_{1,1}) of a 2D oversampled DFT beam; a beam (e.g. i_{1,2}) selected from a set of beams determined according to the beam offset of the 2D oversampled DFT beam; an index (e.g. i_{1,3,l}) corresponding to a maximum amplitude beam; and a wideband amplitude (e.g. i_{1,4,l}), wherein value ranges of wideband amplitudes to which the channel state information of at least two layers corresponds respectively are the same or different. In addition, the subband information (e.g. i₂) includes: a phase combining coefficient (e.g. i_{2,1,l}) and a subband amplitude (e.g. i_{2,2,l}), wherein value ranges of phase combining coefficients to which the channel state information of at least two layers corresponds respectively are the same or different; value ranges of subband amplitudes to which the channel state information of at least two layers corresponds respectively are the same or different.

The method in the embodiments of the present disclosure is described above by taking “a terminal equipment generates CSI based on an AI/ML model and based on a codebook” as examples. In some other embodiments, the network device may further configure the terminal equipment with reportQuatity needing to be fed back, the reportQuatity including at least one of the following: the number of feedback bits of the channel state information of at least two layers, and indices or serial numbers or identifiers of AI/ML models respectively used by the channel state information of at least two layers. Thereby, the terminal equipment may perform corresponding feedback according to configuration of the network device.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

The above embodiments only describe each step or process related to the present disclosure, but the present disclosure is not limited to this. The data transmission method may further include other steps or processes. For specific contents of these steps or processes, related arts may be referred to.

According to the method in the embodiments of the present disclosure, unequal numbers of feedback bits are allocated to two or more subchannels, that is, different feedback precisions are used for two or more subchannels, thus a system gain is improved. Moreover, compared with traditional codebook methods, the feedback precision is further improved.

### Embodiments of a Third Aspect

The embodiments of the present disclosure provide an apparatus for feedback of channel state information, the apparatus may, for example, be a terminal equipment, or may also be one or more parts or components configured in the terminal equipment.

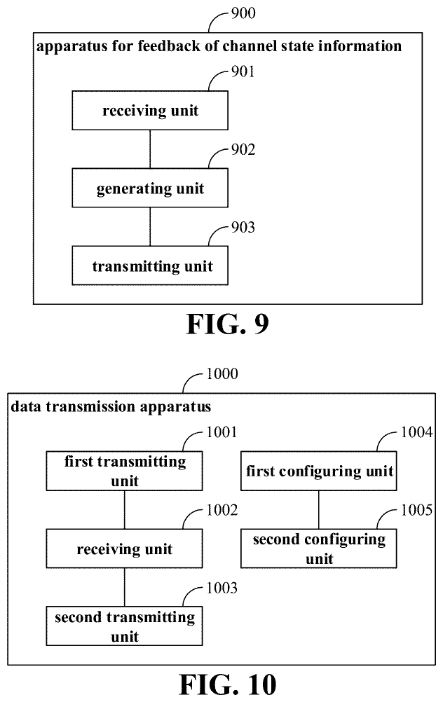

FIG. 9 is a schematic diagram of an apparatus for feedback of channel state information in the embodiments of the present disclosure. The principle of the apparatus to solve the problem is similar to the method in the embodiments of the first aspect, thus its specific implementation may refer to the implementation of the method in the embodiments of the first aspect, the same contents is not repeated. As shown in FIG. 9, the apparatus 900 for feedback of channel state information in the embodiments of the present disclosure includes: a receiving unit 901, a generating unit 902 and a transmitting unit 903.

The receiving unit 901 is configured to receive first information transmitted by a network device, the first information indicating the terminal equipment to generate and feedback channel state information; the generating unit 902 is configured to generate channel state information of N layers, wherein N≥2 and channel state information of at least two layers of the channel state information of N layers is indicated by unequal numbers of bits; and the transmitting unit 903 is configured to transmit the channel state information of N layers to the network device.

In some embodiments, the channel state information of N layers is generated based on a codebook, or is generated based on an AI/ML model.

In some embodiments, the generating unit 902 generates the channel state information of N layers according to a first rule that is predefined or preconfigured or configured by the network device, the first rule including one of the following or a combination thereof: an available AI/ML model;
a criterion and/or method for selecting an AI/ML model;
a criterion and/or method for truncating CSI;
a method for approximating the number of feedback bits;
a maximum number of downlink transmission layers;
a maximum total number of feedback bits; and
a feedback order of CSI.

In the above embodiment, the number of the available AI/ML models is one or more.

In the above embodiment, the criterion and/or method for truncating CSI include(s): if a length of a bit sequence of the CSI is greater than a specified length of a bit sequence, a truncation operation is performed on the bit sequence of the CSI;
if the length of the bit sequence of the CSI is the same as the specified length of the bit sequence, the bit sequence of the CSI is retained.

That the truncation operation is performed on the bit sequence of the CSI includes: performing a truncation operation on the bit sequence of the CSI according to a second rule that is predefined or preconfigured or configured by a network device, the second rule including:
removing a component at a first position in the bit sequence of the CSI, so that a length of the obtained bit sequence of the CSI is the same as a specified length of a bit sequence, wherein the first position is one or more bits of any positions in the bit sequence of the CSI, or,
performing IDFT operation on the bit sequence of the CSI, remove a component at a second position in the bit sequence of the CSI, and perform DFT operation on an obtained bit sequence, so that a length of the obtained bit sequence of the CSI is the same as a specified length of a bit sequence, wherein the second position is one or more bits of any positions in the bit sequence of the CSI.

In the above embodiment, the feedback order of CSI includes an order of values corresponding to CSI from large to small, or an order of the values corresponding to CSI from small to large, or other order agreed upon by a network device and a terminal equipment. The values corresponding to CSI include eigenvalues or singular values of a spatial channel matrix.

In some embodiments, the AI/ML model is a two-sided AI/ML model or a one-sided AI/ML model, the two-sided AI/ML model refers to that the AI/ML model is provided at a network device side and a terminal equipment side; and the one-sided AI/ML model refers to that the AI/ML model is provided at the network device side or the terminal equipment side.

In some embodiments, the transmitting unit 903 further transmits indication information to the network device, the indication information indicating a serial number or index or identifier of an AI/ML model used by the channel state information, so that the network device performs post-processing on the received channel state information according to the serial number or index or identifier of the AI/ML model used by the channel state information, and recovers the post-processed channel state information.

In some embodiments, the receiving unit 901 further receives first configuration information transmitted by a network device, the first configuration information being used for configuring the terminal equipment with value ranges of wideband amplitudes, value ranges of subband amplitudes and value ranges of phase combining coefficients to which the channel state information of at least two layers corresponds respectively, wherein at least one of the value ranges of wideband amplitudes, the value ranges of subband amplitudes and the value ranges of phase combining coefficients to which the channel state information of at least two layers corresponds respectively is different.

In the above embodiment, the channel state information includes PMI that includes wideband information (i₁) or includes wideband information (i₁) and subband information (i₂). The wideband information (i₁) includes: beam offset (i_{1,1}) of a 2D oversampled DFT beam; a beam (i_{1,2}) selected from a set of beams determined according to the beam offset of the 2D oversampled DFT beam; an index (i_{1,3,l}) corresponding to a maximum amplitude beam; and a wideband amplitude (i_{1,4,l}), wherein value ranges of wideband amplitudes to which the channel state information of at least two layers corresponds respectively are the same or different. The subband information (i₂) includes: a phase combining coefficient (i_{2,1,l}) and a subband amplitude (i_{2,2,l}), wherein value ranges of phase combining coefficients to which the channel state information of at least two layers corresponds respectively are the same or different; value ranges of subband amplitudes to which the channel state information of at least two layers corresponds respectively are the same or different.

In some embodiments, the receiving unit 901 further receives second configuration information transmitted by the network device, the second configuration information including reportQuatity needing to be fed back, the reportQuatity needing to be fed back including at least one of the following: the number of feedback bits of the channel state information of at least two layers, and indices or serial numbers or identifiers of AI/ML models respectively used by the channel state information of at least two layers.

It's worth noting that the above embodiments only describe components or modules related to the present disclosure, but the present disclosure is not limited to this. The apparatus 900 for feedback of channel state information may further include other components or modules. For detailed contents of these components or modules, relevant technologies may be referred to.

For the sake of simplicity, FIG. 9 only exemplarily shows a connection relationship or signal direction between components or modules, however persons skilled in the art should know that various relevant technologies such as bus connection may be used. The above components or modules can be realized by a hardware facility such as a processor, a memory, etc. The embodiments of the present disclosure have no limitation to this.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

According to the embodiments of the present disclosure, unequal numbers of feedback bits are allocated to two or more subchannels, that is, different feedback precisions are used for two or more subchannels, thus a system gain is improved. Moreover, compared with traditional codebook methods, the feedback precision is further improved.

### Embodiments of a Fourth Aspect

The embodiments of the present disclosure provide a data transmission apparatus, the apparatus may, for example, be a network device, or may also be one or more parts or components configured in the network device.

FIG. 10 is a schematic diagram of a data transmission apparatus in the embodiments of the present disclosure. The principle of the apparatus to solve the problem is similar to the method in the embodiments of the second aspect, thus its specific implementation may refer to the implementation of the method in the embodiments of the second aspect, the same contents is not repeated. As shown in FIG. 10, the data transmission apparatus 1000 in this embodiment includes: a first transmitting unit 1001, a receiving unit 1002 and a second transmitting unit 1003.

The first transmitting unit 1001 is configured to transmit first information to a terminal equipment, the first information indicating the terminal equipment to generate and feedback channel state information; the receiving unit 1002 is configured to receive channel state information of N layers transmitted by the terminal equipment, wherein N≥2 and channel state information of at least two layers of the channel state information of N layers is indicated by unequal numbers of bits; and the second transmitting unit 1003 is configured to transmit data to the terminal equipment according to the channel state information of N layers.

In some embodiments, that the second transmitting unit 1003 transmits data to the terminal equipment according to the channel state information of N layers includes:
generating a precoding matrix according to the channel state information of N layers;
processing the precoding matrix to data transmitted by the network device to the terminal equipment; and
transmitting the data after being processed by the precoding matrix to the terminal equipment.

In some embodiments, the channel state information of N layers is generated based on a codebook, or is generated based on an AI/ML model.

In some embodiments, the first information includes a first rule where the channel state information of at least two layers is indicated by unequal numbers of bits.

In some embodiments, the first rule is predefined or preconfigured.

In the above embodiments, the first rule includes one of the following or a combination thereof:
an available AI/ML model;
a criterion and/or method for selecting an AI/ML model;
a criterion and/or method for truncating CSI;
a method for approximating the number of feedback bits;
a maximum number of downlink transmission layers;
a maximum total number of feedback bits; and
a feedback order of CSI.

In some embodiments, in the first rule, the number of the available AI/ML models is one or more.

In some embodiments, in the first rule, the criterion and/or method for truncating CSI include(s):
if a length of a bit sequence of the CSI is greater than a specified length of a bit sequence, a truncation operation is performed on the bit sequence of the CSI;
if the length of the bit sequence of the CSI is the same as the specified length of the bit sequence, the bit sequence of the CSI is retained.

In the above embodiments, that the truncation operation is performed on the bit sequence of the CSI includes: performing a truncation operation on the bit sequence of the CSI according to a second rule that is predefined or preconfigured or configured by a network device, the second rule including:
removing a component at a first position in the bit sequence of the CSI, so that a length of the obtained bit sequence of the CSI is the same as a specified length of a bit sequence, wherein the first position is one or more bits of any positions in the bit sequence of the CSI, or,
performing IDFT operation on the bit sequence of the CSI, remove a component at a second position in the bit sequence of the CSI, and perform DFT operation on an obtained bit sequence, so that a length of the obtained bit sequence of the CSI is the same as a specified length of a bit sequence, wherein the second position is one or more bits of any positions in the bit sequence of the CSI.

In some embodiments, in the first rule, a feedback order of CSI includes:
an order of values corresponding to CSI from large to small; or
an order of values corresponding to CSI from small to large.

In the above embodiments, the values corresponding to CSI may include eigenvalues or singular values of a spatial channel matrix.

In some embodiments, the AI/ML model is a two-sided AI/ML model or a one-sided AI/ML model, the two-sided AI/ML model refers to that the AI/ML model is provided at a network device side and a terminal equipment side; and the one-sided AI/ML model refers to that the AI/ML model is provided at the network device side or the terminal equipment side.

In some embodiments, the number of available AI/ML models is more than one, the second transmitting unit 1003 recovers received channel state information using a corresponding AI/ML model according to the available AI/ML model and a criterion and/or method for selecting the AI/ML model.

In some embodiments, the number of available AI/ML models is one, the second transmitting unit 1003 performs post-processing on the received channel state information based on the first rule, and recovers the post-processed channel state information.

In some embodiments, the receiving unit 1002 further receives indication information, the indication information indicating a serial number or index or identifier of an AI/ML model used by the channel state information; the second transmitting unit 1003 performs post-processing on the received channel state information according to the serial number or index or identifier of the AI/ML model used by the channel state information, and recovers the post-processed channel state information.

In each of the above embodiments, that the second transmitting unit 1003 performs post-processing includes:
if a length of a bit sequence of CSI processed by a terminal equipment is greater than a specified length of a bit sequence, since the terminal equipment performs a truncation operation on the CSI, the second transmitting unit 1003 may determine a corresponding lengthening mode according to the criterion and/or method for truncating CSI contained in the first rule, and perform a lengthening operation on the received bit sequence of CSI; if a length of a bit sequence of CSI processed by a terminal equipment is the same as a specified length of a bit sequence, since the terminal equipment does not perform a truncation operation on the CSI, the second transmitting unit 1003 retains the bit sequence of the CSI.

In the above embodiments, that the second transmitting unit 1003 performs a lengthening operation on the bit sequence of the CSI according to the first rule includes: supplementing 0 or 1 or a sequence generated according to a predefined rule to a corresponding bit in a first position; or, performing IDFT operation on a bit sequence needing to be lengthened, supplementing 0 or 1 or a sequence generated according to a predefined rule to a corresponding bit in a second position, then performing DFT operation on an obtained sequence.

In some embodiments, as shown in FIG. 10, the apparatus 1000 further includes:
a first configuring unit 1004 configured to configure a terminal equipment with value ranges of wideband amplitudes, value ranges of subband amplitudes and value ranges of phase combining coefficients to which the channel state information of at least two layers corresponds respectively, wherein at least one of the value ranges of wideband amplitudes, the value ranges of subband amplitudes and the value ranges of phase combining coefficients to which the channel state information of at least two layers corresponds respectively is different.

In the above embodiments, the channel state information includes PMI that includes wideband information (i₁) or includes wideband information (i₁) and subband information (i₂); the wideband information (i₁) includes: beam offset (i_{1,1}) of a 2D oversampled DFT beam; a beam (i_{1,2}) selected from a set of beams determined according to the beam offset of the 2D oversampled DFT beam; an index (i_{1,3,l}) corresponding to a maximum amplitude beam; and a wideband amplitude (i_{1,4,l}), wherein value ranges of wideband amplitudes to which the channel state information of at least two layers corresponds respectively are the same or different; the subband information (i₂) includes: a phase combining coefficient (i_{2,1,l}) and a subband amplitude (i_{2,2,l}), wherein value ranges of phase combining coefficients to which the channel state information of at least two layers corresponds respectively are the same or different, and value ranges of subband amplitudes to which the channel state information of at least two layers corresponds respectively are the same or different.

In some embodiments, as shown in FIG. 10, the apparatus 1000 further includes:
a second configuring unit 1005 configured to configure the terminal equipment with reportQuatity needing to be fed back, the reportQuatity including at least one of the following: the number of feedback bits of the channel state information of at least two layers, and indices or serial numbers or identifiers of AI/ML models respectively used by the channel state information of at least two layers.

It's worth noting that the above embodiments only describe components or modules related to the present disclosure, but the present disclosure is not limited to this. The data transmission apparatus 1000 may further include other components or modules. For detailed contents of these components or modules, relevant technologies can be referred to.

For the sake of simplicity, FIG. 10 only exemplarily shows a connection relationship or signal direction between components or modules, however persons skilled in the art should know that various relevant technologies such as bus connection may be used. The above components or modules can be realized by a hardware facility such as a processor, a memory, etc. The embodiments of the present disclosure have no limitation to this.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

According to the embodiments of the present disclosure, unequal numbers of feedback bits are allocated to two or more subchannels, that is, different feedback precisions are used for two or more subchannels, thus a system gain is improved. Moreover, compared with traditional codebook methods, the feedback precision is further improved.

### Embodiments of a Fifth Aspect

The embodiments of the present disclosure provide a communication system.

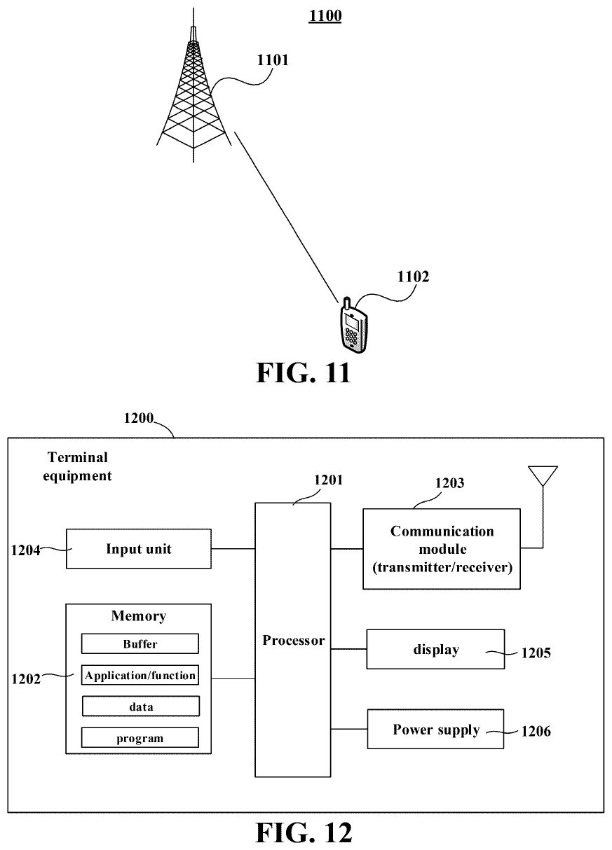

FIG. 11 is a schematic diagram of a communication system in the embodiments of the present disclosure. As shown in FIG. 11, the communication system 1100 in the embodiments of the present disclosure includes a network device 1101 and a terminal equipment 1102. For the sake of simplicity, FIG. 11 only takes a terminal equipment and a network device as examples to describe, but the embodiments of the present disclosure are not limited to this.

In the embodiments of the present disclosure, transmission of existing or further implementable services can be carried out between the network device 1101 and the terminal equipment 1102. For example, these services may include but be not limited to: enhanced Mobile Broadband (eMBB), massive Machine Type Communication (mMTC), Ultra-Reliable Low-Latency Communication (URLLC), Internet of Vehicles (V2X) communication and so on.

In some embodiments, the network device 1101 may be a network device described in the embodiments of the fourth aspect, is configured to perform the method described in the embodiments of the second aspect, specific contents have been described in the embodiments of the second and fourth aspects, and its contents are incorporated here and are not repeated here.

In some embodiments, the terminal equipment 1102 may be a terminal equipment described in the embodiments of the third aspect, is configured to perform the method described in the embodiments of the first aspect, specific contents have been described in the embodiments of the first and third aspects, and its contents are incorporated here and are not repeated here.

The embodiments of the present disclosure further provide a terminal equipment, the terminal equipment for example may be a UE, but the present disclosure is not limited to this, it may also be other equipment.

FIG. 12 is a schematic diagram of a terminal equipment in the embodiments of the present disclosure. As shown in FIG. 12, the terminal equipment 1200 in the embodiments of the present disclosure includes: a processor (such as a central processing unit (CPU)) 1201 and a memory 1202; the memory 1202 stores data and programs, and is coupled to the processor 1201. It's worth noting that this figure is exemplary; other types of structures may also be used to supplement or replace this structure, so as to realize a telecommunication function or other functions.

For example, the processor 1201 may be configured to execute a program to implement the method as described in the embodiments of the first aspect.

As shown in FIG. 12, the terminal equipment 1200 may further include: a communication module 1203, an input unit 1204, a display 1205 and a power supply 1206. The functions of said components are similar to related arts, which are not repeated here. It's worth noting that the terminal equipment 1200 does not have to include all the components shown in FIG. 12, said components are not indispensable. Moreover, the terminal equipment 1200 may also include components not shown in FIG. 12, relevant technologies can be referred to.

The embodiments of the present disclosure further provide a network device, for example the network device may be a base station (gNB), but the present disclosure is not limited to this, it may also be other network device.

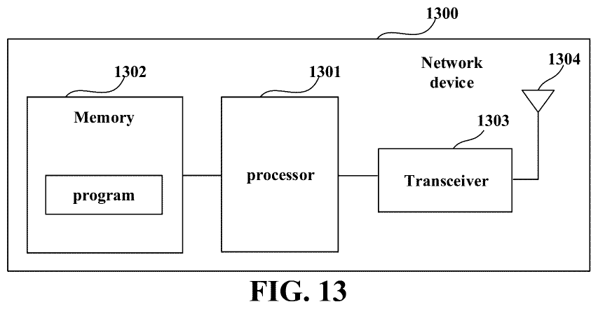

FIG. 13 is a schematic diagram of a network device in the embodiments of the present disclosure. As shown in FIG. 13, the network device 1300 in the embodiments of the present disclosure includes: a processor (such as a central processing unit (CPU)) 1301 and a memory 1302; the memory 1302 is coupled to the processor 1301. The memory 1302 may store various data; moreover, also stores a program for information processing, and executes the program under the control of the central processor 1301.

For example, the processor 1301 can be configured to execute a program to implement the method as described in the embodiments of the second aspect.

In addition, as shown in FIG. 13, the network device 1300 may further include: a transceiver 1303 and an antenna 1304, etc.; wherein the functions of said components are similar to relevant arts, which are not repeated here. It's worth noting that the network device 1300 does not have to include all the components shown in FIG. 13. Moreover, the network device 1300 may further include components not shown in FIG. 13, related arts may be referred to.

The embodiments of the present disclosure further provide a computer readable program, wherein when a terminal equipment executes the program, the program enables a computer to execute the method described in the embodiments of the first aspect, in the terminal equipment.

The embodiments of the present disclosure further provide a storage medium in which a computer readable program is stored, wherein the computer readable program enables a computer to execute the method as described in the embodiments of the first aspect, in the terminal equipment.

The embodiments of the present disclosure further provide a computer readable program, wherein when a network device executes the program, the program enables a computer in the network device to execute the method described in the embodiments of the second aspect.

The embodiments of the present disclosure further provide a storage medium in which a computer readable program is stored, wherein the computer readable program enables a computer to execute the method as described in the embodiments of the second aspect, in a network device.

The apparatus and method in the present disclosure may be realized by hardware, or may be realized by combining hardware with software. The present disclosure relates to such a computer readable program, when the program is executed by a logic component, the computer readable program enables the logic component to realize the apparatus described in the above text or a constituent component, or enables the logic component to realize various methods or steps described in the above text. The logic component is e.g. a field programmable logic component, a microprocessor, a processor used in a computer, etc. The present disclosure further relates to a storage medium storing the program, such as a hard disk, a magnetic disk, an optical disk, a DVD, a flash memory and the like.

By combining with the method/apparatus described in the embodiments of the present disclosure, it may be directly reflected as hardware, a software executed by a processor, or a combination of the two. For example, one or more in the functional block diagram or one or more combinations in the functional block diagram as shown in the drawings may correspond to software modules of a computer program flow, and may also correspond to hardware modules.

These software modules may respectively correspond to the steps as shown in the drawings. These hardware modules may be realized by solidifying these software modules e.g. using a field-programmable gate array (FPGA).

A software module may be located in a RAM memory, a flash memory, a ROM memory, an EPROM memory, an EEPROM memory, a register, a hard disk, a mobile magnetic disk, a CD-ROM or a storage medium in any other form as known in this field. A storage medium may be coupled to a processor, thereby enabling the processor to read information from the storage medium, and to write the information into the storage medium; or the storage medium may be a constituent part of the processor. The processor and the storage medium may be located in an ASIC. The software module may be stored in a memory of a mobile terminal, and may also be stored in a memory card of the mobile terminal. For example, if a device (such as the mobile terminal) adopts a MEGA-SIM card with a larger capacity or a flash memory apparatus with a large capacity, the software module may be stored in the MEGA-SIM card or the flash memory apparatus with a large capacity.

One or more in the functional block diagram or one or more combinations in the functional block diagram as described in the drawings may be implemented as a general-purpose processor for performing the functions described in the present disclosure, a digital signal processor (DSP), an application-specific integrated circuit (ASIC), a field-programmable gate array (FPGA) or other programmable logic device, discrete gate or transistor logic device, discrete hardware components or any combination thereof. One or more in the functional block diagram or one or more combinations in the functional block diagram as described in the drawings may further be implemented as a combination of computer equipments, such as a combination of a DSP and a microprocessor, a plurality of microprocessors, one or more microprocessors combined and communicating with the DSP or any other such configuration.

The present disclosure is described by combining with the specific implementations, however persons skilled in the art should clearly know that these descriptions are exemplary and do not limit the protection scope of the present disclosure. Persons skilled in the art may make various variations and modifications to the present disclosure according to the principle of the present disclosure, these variations and modifications are also within the scope of the present disclosure.

Regarding the above implementations disclosed in this embodiment, the following supplements are further disclosed:

1. A data transmission method, wherein the method includes:
a network device transmits first information to a terminal equipment, the first information indicating the terminal equipment to generate and feedback channel state information;
the network device receives channel state information of N layers transmitted by the terminal equipment, wherein N≥2 and channel state information of at least two layers of the channel state information of N layers is indicated by unequal numbers of bits; and
the network device transmits data to the terminal equipment according to the channel state information of N layers.

2. The method according to Supplement 1, wherein that the network device transmits data to the terminal equipment according to the channel state information of N layers includes:
the network device generates a precoding matrix according to the channel state information of N layers;
the network device processes the precoding matrix to data transmitted by the network device to the terminal equipment; and
the network device transmits the data after being processed by the precoding matrix to the terminal equipment.

3. The method according to Supplement 1, wherein
the channel state information of N layers is generated based on a codebook, or is generated based on an AI/ML model.

4. The method according to Supplement 1, wherein
the first information comprises a first rule where the channel state information of at least two layers is indicated by unequal numbers of bits.

5. The method according to Supplement 1, wherein the method further includes:
predefining or preconfiguring a first rule where the channel state information of at least two layers is indicated by unequal numbers of bits.

6. The method according to Supplement 4 or 5, wherein the first rule comprises one of the following or a combination thereof:
an available AI/ML model;
a criterion and/or method for selecting an AI/ML model;
a criterion and/or method for truncating CSI;
a method for approximating the number of feedback bits;
a maximum number of downlink transmission layers;
a maximum total number of feedback bits; and
a feedback order of CSI.

7. The method according to Supplement 6, wherein the number of the available AI/ML models is one or more.

8. The method according to Supplement 6, wherein the criterion and/or method for truncating CSI include(s):
if a length of a bit sequence of the CSI is greater than a specified length of a bit sequence, a truncation operation is performed on the bit sequence of the CSI;
if the length of the bit sequence of the CSI is the same as the specified length of the bit sequence, the bit sequence of the CSI is retained.

9. The method according to Supplement 8, wherein that the truncation operation is performed on the bit sequence of the CSI includes: performing a truncation operation on the bit sequence of the CSI according to a second rule that is predefined or preconfigured or configured by a network device, the second rule including:
removing a component at a first position in the bit sequence of the CSI, so that a length of the obtained bit sequence of the CSI is the same as a specified length of a bit sequence, wherein the first position is one or more bits of any positions in the bit sequence of the CSI, or,
performing IDFT operation on the bit sequence of the CSI, removing a component at a second position in the bit sequence of the CSI, and performing DFT operation on an obtained bit sequence, so that a length of the obtained bit sequence of the CSI is the same as a specified length of a bit sequence, wherein the second position is one or more bits of any positions in the bit sequence of the CSI.

10. The method according to Supplement 6, wherein the feedback order of CSI includes:
an order of values corresponding to CSI from large to small; or
an order of values corresponding to CSI from small to large.

11. The method according to Supplement 10, wherein the values corresponding to CSI include eigenvalues or singular values of a spatial channel matrix.

12. The method according to any one of Supplements 6 to 11, wherein the AI/ML model is a two-sided AI/ML model or a one-sided AI/ML model,
the two-sided AI/ML model referring to that the AI/ML model is provided at a network device side and a terminal equipment side; and
the one-sided AI/ML model referring to that the AI/ML model is provided at a network device side or a terminal equipment side.

13. The method according to Supplement 6, wherein the number of the available AI/ML models is more than one, and the method further includes:
the network device, according to the available AI/ML model and a criterion and/or method for selecting the AI/ML model, recovers the received channel state information using a corresponding AI/ML model.

14. The method according to Supplement 6, wherein the number of the available AI/ML models is one, and the method further includes:
the network device performs post-processing on the received channel state information based on the first rule; and
the network device recovers the post-processed channel state information.

15. The method according to Supplement 6, wherein the method further includes:
the network device receives indication information, the indication information indicating a serial number or index or identifier of an AI/ML model used by the channel state information; and
the network device performs post-processing on the received channel state information according to the serial number or index or identifier of the AI/ML model used by the channel state information; and
the network device recovers the post-processed channel state information.

16. The method according to Supplement 14 or 15, wherein the post-processing includes:
if a length of a bit sequence of CSI processed by a terminal equipment is greater than a specified length of a bit sequence, determining a corresponding lengthening mode according to the criterion and/or method for truncating CSI contained in the first rule, and performing a lengthening operation on the received bit sequence of the CSI;
if a length of a bit sequence of CSI processed by a terminal equipment is the same as a specified length of a bit sequence, retaining the received bit sequence of the CSI.

17. The method according to Supplement 16, wherein performing a lengthening operation on the bit sequence of the CSI according to the first rule includes:
supplementing 0 or 1 or a sequence generated according to a predefined rule to a corresponding bit in the first position; or
performing IDFT operation on a bit sequence needing to be lengthened, supplementing 0 or 1 or a sequence generated according to a predefined rule to a corresponding bit in the second position, then performing DFT operation on an obtained sequence.

18. The method according to Supplement 1, wherein the network device configures the terminal equipment with value ranges of wideband amplitudes, value ranges of subband amplitudes and value ranges of phase combining coefficients to which the channel state information of at least two layers corresponds respectively, wherein at least one of the value ranges of wideband amplitudes, the value ranges of subband amplitudes and the value ranges of phase combining coefficients to which the channel state information of at least two layers corresponds respectively is different.

19. The method according to Supplement 18, wherein the channel state information includes PMI that includes wideband information (i₁) or includes wideband information (i₁) and subband information (i₂),
the wideband information (i₁) including:
   beam offset (i_{1,1}) of a 2D oversampled DFT beam;
   a beam (i_{1,2}) selected from a set of beams determined according to the beam offset of the 2D oversampled DFT beam;
   an index (i_{1,3,l}) corresponding to a maximum amplitude beam; and
   a wideband amplitude (i_{1,4,l}), wherein value ranges of wideband amplitudes to which the channel state information of at least two layers corresponds respectively are the same or different;
the subband information (i₂) including:
   a phase combining coefficient (i_{2,1,l}), value ranges of phase combining coefficients to which the channel state information of at least two layers corresponds respectively are the same or different; and
a subband amplitude (i_{2,2,l}), value ranges of subband amplitudes to which the channel state information of at least two layers corresponds respectively are the same or different.

20. The method according to Supplement 1, wherein the method further includes:
the network device configures the terminal equipment with reportQuatity needing to be fed back, the reportQuatity including at least one of the following: the number of feedback bits of the channel state information of at least two layers, and indices or serial numbers or identifiers of AI/ML models respectively used by the channel state information of at least two layers.

21. A method for feedback of channel state information, wherein the method includes:
a terminal equipment receives first information transmitted by a network device, the first information indicating the terminal equipment to generate and feedback channel state information;
the terminal equipment generates channel state information of N layers, wherein N≥2 and channel state information of at least two layers of the channel state information of N layers is indicated by unequal numbers of bits; and
the terminal equipment transmits the channel state information of N layers to the network device.

22. The method according to Supplement 21, wherein the channel state information of N layers is generated based on a codebook, or is generated based on an AI/ML model.

23. The method according to Supplement 21, wherein the terminal equipment generates the channel state information of N layers according to a first rule that is predefined or preconfigured or configured by the network device, the first rule comprising one of the following or a combination thereof:
an available AI/ML model;
a criterion and/or method for selecting an AI/ML model;
a criterion and/or method for truncating CSI;
a method for approximating the number of feedback bits;
a maximum number of downlink transmission layers;
a maximum total number of feedback bits; and
a feedback order of CSI.

24. The method according to Supplement 23, wherein the number of the available AI/ML models is one or more.

25. The method according to Supplement 23, wherein the criterion and/or method for truncating CSI include(s):
if a length of a bit sequence of the CSI is greater than a specified length of a bit sequence, a truncation operation is performed on the bit sequence of the CSI;
if the length of the bit sequence of the CSI is the same as the specified length of the bit sequence, the bit sequence of the CSI is retained.

26. The method according to Supplement 25, wherein that the truncation operation is performed on the bit sequence of the CSI includes: performing a truncation operation on the bit sequence of the CSI according to a second rule that is predefined or preconfigured or configured by a network device, the second rule including:
removing a component at a first position in the bit sequence of the CSI, so that a length of the obtained bit sequence of the CSI is the same as a specified length of a bit sequence, wherein the first position is one or more bits of any positions in the bit sequence of the CSI, or,
performing IDFT operation on the bit sequence of the CSI, removing a component at a second position in the bit sequence of the CSI, and performing DFT operation on an obtained bit sequence, so that a length of the obtained bit sequence of the CSI is the same as a specified length of a bit sequence, wherein the second position is one or more bits of any positions in the bit sequence of the CSI.

27. The method according to Supplement 23, wherein the feedback order of CSI includes:
an order of values corresponding to CSI from large to small; or
an order of values corresponding to CSI from small to large.

28. The method according to Supplement 27, wherein the values corresponding to CSI include eigenvalues or singular values of a spatial channel matrix.

29. The method according to any one of Supplements 23 to 28, wherein the AI/ML model is a two-sided AI/ML model or a one-sided AI/ML model,
the two-sided AI/ML model referring to that the AI/ML model is provided at a network device side and a terminal equipment side; and
the one-sided AI/ML model referring to that the AI/ML model is provided at a network device side or a terminal equipment side.

30. The method according to Supplement 23, wherein the method further includes:
the terminal equipment transmits indication information to the network device, the indication information indicating a serial number or index or identifier of an AI/ML model used by the channel state information, so that the network device performs post-processing on the received channel state information according to the serial number or index or identifier of the AI/ML model used by the channel state information, and recovers the post-processed channel state information.

31. The method according to Supplement 21, wherein the method further includes:
the terminal equipment receives first configuration information transmitted by the network device, the first configuration information being used for configuring the terminal equipment with value ranges of wideband amplitudes, value ranges of subband amplitudes and value ranges of phase combining coefficients to which the channel state information of at least two layers corresponds respectively, wherein at least one of the value ranges of wideband amplitudes, the value ranges of subband amplitudes and the value ranges of phase combining coefficients to which the channel state information of at least two layers corresponds respectively is different.

32. The method according to Supplement 31, wherein the channel state information includes PMI that includes wideband information (i₁) or includes wideband information (i₁) and subband information (i₂),
the wideband information (i₁) including:
   beam offset (i_{1,1}) of a 2D oversampled DFT beam;
   a beam (i_{1,2}) selected from a set of beams determined according to the beam offset of the 2D oversampled DFT beam;
an index (i_{1,3,l}) corresponding to a maximum amplitude beam; and
a wideband amplitude (i_{1,4,l}), value ranges of wideband amplitudes to which the channel state information of at least two layers corresponds respectively are the same or different; the subband information (i₂) including:
a phase combining coefficient (i_{2,1,l}), value ranges of phase combining coefficients to which the channel state information of at least two layers corresponds respectively are the same or different; and
a subband amplitude (i_{2,2,l}), value ranges of subband amplitudes to which the channel state information of at least two layers corresponds respectively are the same or different.

33. The method according to Supplement 21, wherein the method further includes:
the terminal equipment receives second configuration information transmitted by the network device, the second configuration information including reportQuatity needing to be fed back, the reportQuatity needing to be fed back including at least one of the following: the number of feedback bits of the channel state information of at least two layers, and indices or serial numbers or identifiers of AI/ML models respectively used by the channel state information of at least two layers.

34. A network device, comprising a memory and a processor, the memory storing a computer program, and the processor being configured to execute the computer program to implement the method according to any one of Supplements 1 to 20.

35. A terminal equipment, comprising a memory and a processor, the memory storing a computer program, and the processor being configured to execute the computer program to implement the method according to any one of Supplements 21 to 33.

36. A communication system, comprising a terminal equipment and a network device, wherein
the terminal equipment is configured to execute the method according to any one of Supplements 21 to 33, and the network device is configured to execute the method according to any one of Supplements 1 to 20.

1. A data transmission apparatus, configured in a network device, wherein the apparatus comprises:
a first transmitting unit configured to transmit first information to a terminal equipment, the first information indicating the terminal equipment to generate and feedback channel state information;
a receiving unit configured to receive channel state information of N layers transmitted by the terminal equipment, wherein N≥2 and channel state information of at least two layers of the channel state information of N layers is indicated by unequal numbers of bits; and
a second transmitting unit configured to transmit data to the terminal equipment according to the channel state information of N layers.

2. The apparatus according to claim 1, wherein the second transmitting unit generates a precoding matrix according to the channel state information of N layers, processes the precoding matrix to data transmitted by the network device to the terminal equipment, and transmits the data after being processed by the precoding matrix to the terminal equipment.

3. The apparatus according to claim 1, wherein
the channel state information of N layers is generated based on a codebook, or is generated based on an artificial intelligence/machine learning model.

4. The apparatus according to claim 1, wherein
the first information comprises a first rule where the channel state information of at least two layers is indicated by unequal numbers of bits.

5. The apparatus according to claim 4, wherein the first rule is predefined or preconfigured.

6. The apparatus according to claim 4, wherein the first rule comprises one of the following or a combination thereof:
available artificial intelligence/machine learning models;
a criterion and/or method for selecting an artificial intelligence/machine learning model;
a criterion and/or method for truncating channel state information;
a method for approximating the number of feedback bits;
a maximum number of downlink transmission layers;
a maximum total number of feedback bits; and
a feedback order of channel state information.

7. The apparatus according to claim 6, wherein the number of the available artificial intelligence/machine learning models is more than one, and the second transmitting unit, according to the available artificial intelligence/machine learning models and the criterion and/or method for selecting an artificial intelligence/machine learning model, recovers the received channel state information by using a corresponding artificial intelligence/machine learning model.

8. The apparatus according to claim 6, wherein the number of the available artificial intelligence/machine learning models is one, and the second transmitting unit performs post-processing on the received channel state information based on the first rule, and recovers the post-processed channel state information.

9. The apparatus according to claim 6, wherein
the receiving unit further receives indication information, the indication information indicating a serial number or index or identifier of an artificial intelligence/machine learning model used by the channel state information; and
the second transmitting unit performs post-processing on the received channel state information according to the serial number or index or identifier of the artificial intelligence/machine learning model used by the channel state information, and recovers the post-processed channel state information.

10. The apparatus according to claim 1, wherein the apparatus further comprises:
a first configuring unit configured to configure the terminal equipment with value ranges of wideband amplitudes, value ranges of subband amplitudes and value ranges of phase combining coefficients to which the channel state information of at least two layers corresponds respectively, wherein at least one of the value ranges of wideband amplitudes, the value ranges of subband amplitudes and the value ranges of phase combining coefficients to which the channel state information of at least two layers corresponds respectively is different.

11. The apparatus according to claim 6, wherein the artificial intelligence/machine learning model is a two-sided artificial intelligence/machine learning model or a one-sided artificial intelligence/machine learning model,
the two-sided artificial intelligence/machine learning model referring to that the artificial intelligence/machine learning model is provided at a network device side and a terminal equipment side; and
the one-sided artificial intelligence/machine learning model referring to that the artificial intelligence/machine learning model is provided at the network device side or the terminal equipment side.

12. The apparatus according to claim 1, wherein the apparatus further comprises:
a second configuring unit configured to configure the terminal equipment with a report quality needing to be fed back, the report quality including at least one of the following: the number of feedback bits of the channel state information of at least two layers, and indices or serial numbers or identifiers of artificial intelligence/machine learning models respectively used by the channel state information of at least two layers.

13. An apparatus for feedback of channel state information, configured in a terminal equipment, wherein the apparatus comprises:
a receiving unit configured to receive first information transmitted by a network device, the first information indicating the terminal equipment to generate and feedback channel state information;
a generating unit configured to generate channel state information of N layers, wherein N≥2 and channel state information of at least two layers of the channel state information of N layers is indicated by unequal numbers of bits; and
a transmitting unit configured to transmit the channel state information of N layers to the network device.

14. The apparatus according to claim 13, wherein the channel state information of N layers is generated based on a codebook, or is generated based on an artificial intelligence/machine learning model.

15. The apparatus according to claim 13, wherein the generating unit generates the channel state information of N layers according to a first rule that is predefined or preconfigured or configured by the network device, the first rule comprising one of the following or a combination thereof:
available artificial intelligence/machine learning models;
a criterion and/or method for selecting an artificial intelligence/machine learning model;
a criterion and/or method for truncating channel state information;
a method for approximating the number of feedback bits;
a maximum number of downlink transmission layers;
a maximum total number of feedback bits; and
a feedback order of channel state information.

16. The apparatus according to claim 15, wherein
the transmitting unit transmits indication information to the network device, the indication information indicating a serial number or index or identifier of an artificial intelligence/machine learning model used by the channel state information, so that the network device performs post-processing on the received channel state information according to the serial number or index or identifier of the artificial intelligence/machine learning model used by the channel state information, and recovers the post-processed channel state information.

17. The apparatus according to claim 13, wherein
the receiving unit receives first configuration information transmitted by the network device, the first configuration information being used for configuring the terminal equipment with value ranges of wideband amplitudes, value ranges of subband amplitudes and value ranges of phase combining coefficients to which the channel state information of at least two layers corresponds respectively, wherein at least one of the value ranges of wideband amplitudes, the value ranges of subband amplitudes and the value ranges of phase combining coefficients to which the channel state information of at least two layers corresponds respectively is different.

18. The apparatus according to claim 15, wherein the artificial intelligence/machine learning model is a two-sided artificial intelligence/machine learning model or a one-sided artificial intelligence/machine learning model,
the two-sided artificial intelligence/machine learning model referring to that the artificial intelligence/machine learning model is provided at a network device side and a terminal equipment side; and
the one-sided artificial intelligence/machine learning model referring to that the artificial intelligence/machine learning model is provided at the network device side or the terminal equipment side.

19. The apparatus according to claim 13, wherein
the receiving unit receives second configuration information transmitted by the network device, the second configuration information including a report quality needing to be fed back, the report quality needing to be fed back including at least one of the following: the number of feedback bits of the channel state information of at least two layers, and indices or serial numbers or identifiers of artificial intelligence/machine learning models respectively used by the channel state information of at least two layers.

20. A communication system, comprising a terminal equipment and a network device, wherein
the network device is configured to:
transmit first information to the terminal equipment, the first information indicating the terminal equipment to generate and feedback channel state information;
receive channel state information of N layers transmitted by the terminal equipment, wherein N≥2 and channel state information of at least two layers of the channel state information of N layers is indicated by unequal numbers of bits; and
transmit data to the terminal equipment according to the channel state information of N layers;
and the terminal equipment is configured to:
receive the first information transmitted by the network device;
generate the channel state information of N layers; and
transmit the channel state information of N layers to the network device.
